(19) United States
(12) Patent Application Publication
(10) Pub. No.: US 2015/0212436 A1
(43) Pub. Date: Jul. 30, 2015

(54) ELECTROPHOTOGRAPHIC PHOTORECEPTOR, ELECTROPHOTOGRAPHIC PHOTORECEPTOR CARTRIDGE, AND IMAGE FORMING APPARATUS

(71) Applicant: MITSUBISHI CHEMICAL CORPORATION, Chiyoda-ku (JP)

(72) Inventors: Akiteru FUJII, Kanagawa (JP); Mitsuo WADA, Kanagawa (JP); Yuka NAGAO, Kanagawa (JP)

(73) Assignee: MITSUBISHI CHEMICAL CORPORATION, Chiyoda-ku (JP)

(21) Appl. No.: 14/608,839

(22) Filed: Jan. 29, 2015

Related U.S. Application Data
(63) Continuation of application No. PCT/JP2013/070646, filed on Jul. 30, 2013.

(30) Foreign Application Priority Data
Jul. 31, 2012 (JP) 2012-170115

(51) Int. Cl. G03G 15/00

(52) U.S. Cl. CPC G03G 5/0618; G03G 5/0614; G03G 5/0546

(57) ABSTRACT

The present invention is intended to provide an electrophotographic photoreceptor that does not easily cause defects such as filming, insufficient cleaning, and abnormal noise, and that has many other desirable properties, including excellent abrasion resistance, excellent adhesion to a substrate and a lower layer, excellent electrical properties including fast response and sufficiently low exposure electric potential, and excellent gas resistance and image memory characteristics. The present invention relates to an electrophotographic photoreceptor that has at least a photosensitive layer on an electrocondutive support. The photosensitive layer contains a charge transport substance of a specific structure, and a specific polyester resin.

### TECHNICAL FIELD

The present invention relates to an electrophotographic photoreceptor having excellent electrical properties and mechanical properties, an electrophotographic photoreceptor cartridge produced with the electrophotographic photoreceptor, and an image forming apparatus.

### BACKGROUND ART

The electrophotographic technique instantaneously produces high quality images, and is in wide use in applications such as in copiers, printers, and printing machines. A photoreceptor using an organic photoconductive substance has various advantages including environmental cleanness, ease of deposition, and ease of production, and has been used as an electrophotographic photoreceptor (hereinafter, simply “photoreceptor”), a key component of the electrophotographic technique.

In response to the recent demands for higher image quality, the trend for smaller toner size has been increasing, and the chemical toner in particular often has a shape close to a sphere. This tends to cause slipping of the blade when cleaning the toner remaining on the photoreceptor, and image defects such as scumming are likely to occur. As a countermeasure, a cleaning blade is often brought into contact with the photoreceptor under strong pressure to prevent toner slipping.

Increasing the contact pressure of a cleaning blade against the photoreceptor causes chatter due to stick-slip, a phenomenon in which a blade repeatedly sticks and slips against the outermost surface of the photoreceptor. This increases the risk of causing insufficient cleaning and abnormal noise.

Further, because the photoreceptor rotates under the strong pressure of the cleaning blade pressing the toner component external additive and toner carrier at the nip portion, the photoreceptor lifetime becomes shorter as the photosensitive layer wears out, and scratches made in circumferential direction tend to cause image defects. Another problem is that the filming phenomenon, in which the external additive, wax, and other toner components adhere to the photoreceptor surface and cannot be easily removed, easily occurs, and increases the risk of causing persistent image defects.

The photoreceptor is thus required to have surface mechanical properties that minimize the occurrence of image defects, abnormal noise, and short lifetime even when used under more severe conditions. It has been proposed to improve surface mechanical properties by providing a protective layer on the outermost surface of a photoreceptor. However, this involves low productivity and high cost, and is not readily applicable except for a part of high-end applications.

A polyester resin, particularly polyallylate resin (wholly aromatic polyester resin) having high elastic deformation rate has actually been used for the outermost layer of a photoreceptor to meet the demand for improved mechanical properties under severe conditions (Patent Literature 1).

Meanwhile, the trend for smaller photoreceptors has been increasing along with the movement toward smaller and faster electrophotographic devices, and the demand for faster electrical response (a quick drop of the photoreceptor surface electric potential after exposure) has been higher. In order to provide an electrophotographic photoreceptor of characteristics satisfying such requirements, a high-function charge transport substance that has high mobility and shows a sufficiently low residual electric potential at expose needs to be developed. In this connection, there are many studies of charge transport substances in which the it electron system is expanded with styryl or the like in a triphenylamine skeleton or tetraphenylbenzidine skeleton (Patent Literatures 2 to 8).

Specifically, the photosensitive layer of an electrophotographic photoreceptor using an organic material is obtained by dissolving materials such as a charge transport substance and a binder resin in a coating solvent, and applying and drying the resulting coating liquid. The properties required of the charge transport substance used for the production of the electrophotographic photoreceptor are the solubility for the coating solvent, and the compatibility with the binder resin used for the production of the coating liquid. With poor solubility and compatibility, it may not be possible to dissolve the desired amount of charge transport substance in a coating solvent, or the coating liquid may easily deteriorate such as by precipitation after being produced by dissolving a charge transport substance. Poor solubility and compatibility may also lead to poor production efficiency of the coating liquid and the photoreceptor by causing crystal precipitation in the coated film of the coated photosensitive layer.

As a rule, compounds with the expended it electron system within the molecule tend to increase intermolecular interaction and decrease solubility as the molecule size increases. The tetraphenylbenzidine skeleton in the foregoing publications has a large molecule size, and the solubility tends to be low. Expanding the π electron system within the molecule by introducing substituents such as styryl to the tetraphenylbenzidine skeleton further increases the molecule size, and the solubility for the coating solvent becomes even lower. In some of the foregoing reports, the solubility is maintained by taking measures such as introducing a new substituent, or treating the compound as a geometric isomer mixture (Patent Literature 9).

### CITATION LIST

### Patent Literature

Patent Literature 1: JP-A-2006-053549
Patent Literature 2: JP-A-62-120347
Patent Literature 3: JP-A-63-163361
Patent Literature 4: JP-A-7-36203
Patent Literature 5: JP-A-2003-131409
Patent Literature 6: JP-A-2008-70591
Patent Literature 7: Japanese Patent No. 2940502
Patent Literature 8: JP-A-2008-70591
Patent Literature 9: JP-A-2002-80432

### SUMMARY OF INVENTION

### Technical Problem

As described above, the conventional polycarbonate binder resin is insufficient as a photoreceptor suited for use with chemical toners, and polyester resins have been studied to provide alternative materials. However, polyester resins have larger molecule polarity and relatively poorer charge transportability than polycarbonate resins, and many of the conventional charge transport substances are insufficient in terms of properties such as responsiveness and residual electric potential, and are not usable in processes requiring high response. Charge transport substances having high charge mobility are available. However, while many of such materials have desirable responsiveness, they are insufficient in terms of the extent of a residual electric potential drop. Because this necessitates using the material in relatively larger amounts than the binder resin, such charge transport substances are often poor in terms of abrasion resistance.

Conversely, many of the charge transport substances with sufficiently low residual electric potential have poor response, and are not usable for high speed processes. There are materials having desirable residual electric potential and desirable response. However, these materials are often not sufficient in terms of gas resistance (for example, against ozone and NOₓ), image memory characteristics, and compatibility to polyester resin, and are not usable in many applications.

The present invention has been made under these circumstances, and it is an object of the present invention to provide an electrophotographic photoreceptor that sufficiently exhibits abrasion resistance, a quality essential for long life, and that does not easily cause problems such as filming, insufficient cleaning, and abnormal noise, and that has many other desirable properties, including excellent adhesion to a substrate and a lower layer, excellent electrical properties including fast response and sufficiently low exposure electric potential, and excellent gas resistance and image memory characteristics. The invention is also intended to provide an electrophotographic cartridge, and an image forming apparatus.

### Solution to Problem

The present inventors conducted intensive studies, and found that an electrophotographic photoreceptor that desirably exhibits characteristics necessary for long life such as sufficient abrasion resistance, filming resistance, and adhesion, and that shows a sufficiently low residual electric potential at exposure can be provided by containing a charge transport substance of a specific structure in a photosensitive layer that contains a specific polyester resin. The present invention was completed on the basis of this finding.

The gist of the present invention resides in the following <1> to <8>.

<1> An electrophotographic photoreceptor comprising an electrocondutive support and at least a photosensitive layer on the support,

wherein the photosensitive layer contains a charge transport substance represented by the following formula (1), and a polyester resin having a structure unit represented by the following formula (2),

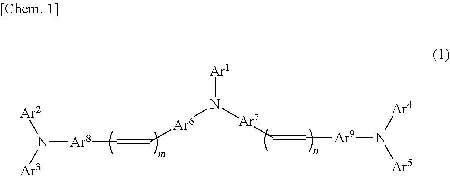

wherein Ar¹ to Ar⁵ each independently represent optionally substituted aryl group, Ar⁶ to Ar⁹ each independently represent optionally substituted arylene group, and m and n each independently represent an integer of 1 to 3,

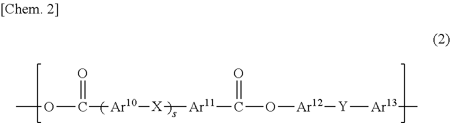

wherein Ar¹⁰ to Ar¹³ each independently represent optionally substituted arylene group, X and Y each independently represent a single bond, an oxygen atom, a sulfur atom, or alkylene group, and s represents an integer of 0 to 2, wherein, when s is 2, a plurality of Ar¹⁰s and Xs each may be the same or different.
<2> The electrophotographic photoreceptor according to the <1> above, wherein, in the formula (1), Ar¹ to Ar⁵ are each independently aryl group of 30 or less carbon atoms that may have alkyl group or alkoxy group, Ar⁶ to Ar⁹ are each independently optionally substituted 1,4-phenylene group, and m and n are each independently 1 or 2.
<3> The electrophotographic photoreceptor according to the <1> or <2>, wherein the charge transport substance represented by the formula (1) contained in one or more layers forming the photosensitive layer is 15 to 50 mass parts with respect to 100 mass parts of a binder resin contained in the same layer.
<4> The electrophotographic photoreceptor according to any one of the <1> to <3> above, wherein the photosensitive layer contains oxytitanium phthalocyanine of a crystal form that shows a diffraction peak at a Bragg angle (2θ±0.2°) of at least 24.1° and 27.2° in a powder X-ray diffraction spectrum using a CuKα characteristic X-ray.
<5> The electrophotographic photoreceptor according to any one of the <1> to <4> above, wherein, when s in the formula (2) is 0, at least one of Ar¹² and Ar¹³ is a an arylene group having an alkyl group.
<6> The electrophotographic photoreceptor according to any one of the <1> to <5> above, wherein the photosensitive layer contains a benzylamine derivative.
<7> A electrophotographic photoreceptor cartridge comprising:

the electrophotographic photoreceptor of any one of the <1> to <6> above; and

at least one device selected from the group consisting of:
a charging device that charges the electrophotographic photoreceptor;
an exposure device that exposes the charged electrophotographic photoreceptor and forms an electrostatic latent image; and
a developing device that develops the electrostatic latent image formed on the electrophotographic photoreceptor.
   <8> An image forming apparatus comprising:

the electrophotographic photoreceptor of any one of the <1> to <6> above;

a charging device that charges the electrophotographic photoreceptor;

an exposure device that exposes the charged electrophotographic photoreceptor and forms an electrostatic latent image; and

a developing device that develops the electrostatic latent image formed on the electrophotographic photoreceptor.

### Advantageous Effects of Invention

The present invention can provide an electrophotographic photoreceptor preferred for use in applications where long life is required, specifically an electrophotographic photoreceptor that includes a photosensitive layer containing a charge transport substance of a specific structure, and a polyester resin, and that has desirable properties including abrasion resistance, fast response, low residual electric potential, excellent filming resistance, and adhesion.

### BRIEF DESCRIPTION OF DRAWINGS

FIG. 1 is a schematic diagram representing the configuration of a relevant portion of an embodiment of an image forming apparatus according to the present invention.

FIG. 2 is an X-ray diffraction diagram of an oxytitanium phthalocyanine used in Examples.

### DESCRIPTION OF EMBODIMENTS

An embodiment of the present invention is described below in detail. The constituting elements described in the following detailed descriptions are intended to provide representative examples of an embodiment of the present invention, and may be practiced with modifications as may be appropriately made within the scope of the gist of the present invention.

As used herein, “weight %”, “weight part”, and “weight ratio” have the same meaning as “mass %”, “mass part”, and “mass ratio”, respectively.

### Charge Transport Substance of the Present Invention

### Structure of Charge Transport Substance of the Present Invention

The charge transport substance of the present invention may be any of the compounds represented by the following formula (1).

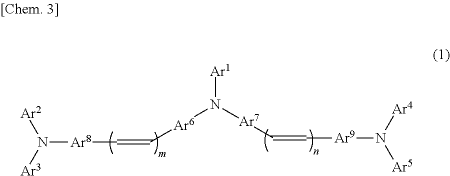

(In the formula (1), Ar¹ to Ar⁵ each independently represent optionally substituted aryl group, and Ar⁶ to Ar⁹ each independently represent optionally substituted arylene group. The symbols m and n each independently represent an integer of 1 to 3.)

In the formula (1), Ar¹ to Ar⁵ each independently represent optionally substituted aryl group. The aryl group has typically 30 or less, preferably 20 or less, further preferably 15 or less carbon atoms.

Specific examples include phenyl group, naphthyl group, biphenyl group, anthryl group, and phenanthryl group. In terms of compatibility, the aryl group is preferably phenyl group, naphthyl group, or anthryl group. In terms of charge transportability, the aryl group is more preferably phenyl group or naphthyl group, further preferably phenyl group.

Examples of the possible substituents of Ar¹ to Ar⁵ include alkyl group, aryl group, alkoxy group, and a halogen atom.

Specific examples of the alkyl group include linear alkyl group such as methyl group, ethyl group, n-propyl group, and n-butyl group; branched alkyl group such as isopropyl group, and ethylhexyl group; and cyclic alkyl group such as cyclohexyl group, and cyclopentyl group.

Examples of the aryl group include optionally substituted phenyl group and naphthyl group.

Examples of the alkoxy group include linear alkoxy group such as methoxy group, ethoxy group, n-propoxy group, and n-butoxy group; branched alkoxy group such as isopropoxy group, and ethylhexyloxy group; cyclic alkoxy group such as cyclohexyloxy group; and alkoxy group having fluorine atoms, such as trifluoromethoxy group, pentafluoroethoxy group, and 1,1,1-trifluoroethoxy group.

Examples of the halogen atom include a fluorine atom, a chlorine atom, and a bromine atom.

In terms of raw material versatility, Ar¹ to Ar⁵ are preferably alkyl group of 1 to 20 carbon atoms, or alkoxy group of 1 to 20 carbon atoms. In terms of ease of handling in production, Ar¹ to Ar⁵ are more preferably alkyl group of 1 to 12 carbon atoms, or alkoxy group of 1 to 12 carbon atoms. In terms of the light attenuation property as an electrophotographic photoreceptor, Ar¹ to Ar⁵ are further preferably alkyl group of 1 to 6 carbon atoms, or alkoxy group of 1 to 6 carbon atoms.

When Ar¹ to Ar⁵ are phenyl group, it is preferable to have a substituent in terms of charge transportability. The number of substituents may be 1 to 5, and is preferably 1 to 3 in terms of raw material versatility, further preferably 1 to 2 in terms of electrophotographic photoreceptor characteristics.

In this case, Ar² to Ar⁵ have substituents preferably at the ortho or para position with respect to the nitrogen atom in terms of electrical properties, and at the meta position in terms of compatibility.

Ar¹ preferably has at least one substituent at the ortho or para position with respect to the nitrogen atom, more preferably at the para position in terms of electrical properties.

The substituent is preferably alkoxy group of 1 to 6 carbon atoms, or alkyl group of 1 to 12 carbon atoms in terms of solubility.

When Ar¹ to Ar⁵ are naphthyl group, the number of substituents is preferably 0 to 2, more preferably 0 to 1 in terms of raw material versatility.

Ar⁶ to Ar⁹ in the formula (1) each independently represent optionally substituted arylene group. The aryl group has typically 30 or less carbon atoms, preferably 20 or less carbon atoms, further preferably 15 or less carbon atoms.

Specific examples include phenylene group, biphenylene group, naphthylene group, anthrylene group, and phenanthrylene group. Preferred in terms of compatibility are phenylene group and naphthylene group, more preferably phenylene group.

Examples of the possible substituents of Ar⁶ to Ar⁹ include alkyl group, aryl group, alkoxy group, and a halogen atom.

Specific examples of the alkyl group include linear alkyl group such as methyl group, ethyl group, n-propyl group, and n-butyl group; branched alkyl group such as isopropyl group, and ethylhexyl group; and cyclic alkyl group such as cyclohexyl group, and cyclopentyl group.

Examples of the aryl group include optionally substituted phenyl group and naphthyl group.

Examples of the alkoxy group include linear alkoxy group such as methoxy group, ethoxy group, n-propoxy group, and n-butoxy group; branched alkoxy group such as isopropoxy group, and ethylhexyloxy group; cyclic alkoxy group such as cyclohexyloxy group; and alkoxy group having fluorine atoms, such as trifluoromethoxy group, pentafluoroethoxy group, and 1,1,1-trifluoroethoxy group.

Examples of the halogen atom include a fluorine atom, a chlorine atom, and a bromine atom.

In terms of raw material versatility, the possible substituents of Ar⁶ to Ar⁹ are preferably alkyl group of 1 to 6 carbon atoms, or alkoxy group of 1 to 6 carbon atoms. In terms of ease of handling in production, the possible substituents of Ar⁶ to Ar⁹ are more preferably alkyl group of 1 to 4 carbon atoms, or alkoxy group of 1 to 4 carbon atoms. In terms of the light attenuation property as an electrophotographic photoreceptor, the possible substituents of Ar⁶ to Ar⁹ are further preferably methyl group, ethyl group, methoxy group, or ethoxy group.

Any substituent present in Ar⁶ to Ar⁹ creates a torsion in the molecular structure, and prevents the expansion of π conjugation within the molecule. Because this may lower the electron transportability, Ar⁶ to Ar⁹ preferably do not have a substituent. More preferably, Ar⁶ to Ar⁹ are 1,3-phenylene group, 1,4-phenylene group, 1,4-naphthylene group, 2,6-naphthylene group, or 2,8-naphthylene group in terms of electrophotographic photoreceptor characteristics, and further preferably 1,4-phenylene group in terms of electrical properties.

The symbols m and n each independently represent an integer of 1 to 3. Any larger values tend to lower the solubility for a coating solvent, and m and n are preferably 2 or less, and are more preferably 1 in terms of charge transportability as a charge transport substance.

When m and n are 1, the groups represented by the parentheses in the compound represented by formula (1) are ethenyl. Here, the compound represented by formula (1) has geometric isomers, and is preferably a trans isomer in terms of electrophotographic photoreceptor characteristics.

When m and n are 2, the groups represented by the parentheses in the compound represented by formula (1) are butadienyl group. Here, the compound represented by formula (1) also has geometric isomers, and is preferably a mixture of two or more geometric isomers in terms of coating liquid storage stability.

The electrophotographic photoreceptor of the present invention may contain the compound of formula (1) alone in the photosensitive layer, or may contain a mixture of the compounds represented by formula (1).

In terms of photoreceptor electrical properties, the compound represented by formula (1) is particularly preferably the compound represented by the following formula (1a). The compound of formula (1a) is a compound represented by formula (1) in which Ar¹ is phenyl group having alkyl group, alkoxy group, aryloxy group, or aralkyloxy group, Ar² to Ar⁵ are each independently phenyl group that may have alkyl group of 1 to 6 carbon atoms as a substituent, Ar⁶ to Ar⁹ are all unsubstituted 1,4-phenylene group, R¹ to R⁴ are all hydrogen atoms, and m and n are both 1.

### [Chem. 4]

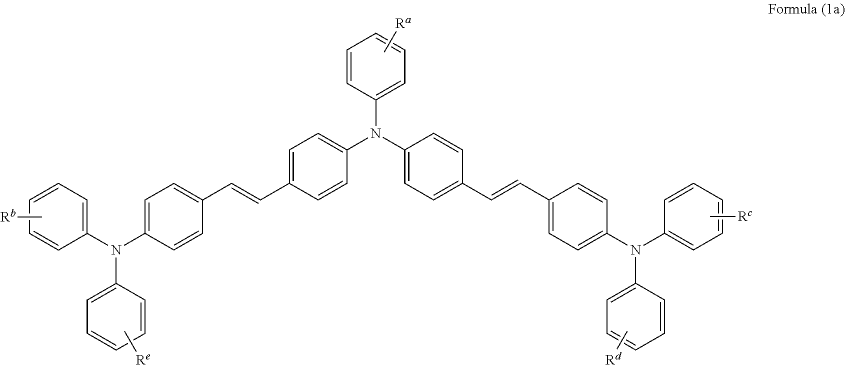

(In the formula (1a), R^{a} represents alkyl group, alkoxy group, aryloxy group, or aralkyloxy group, and R^{b} to R^{e} each independently represent alkyl group of 1 to 6 carbon atoms, or a hydrogen atom.)

### Producing Process of Charge Transport Substance of the Present Invention

The charge transport substance of the foregoing exemplary embodiment may be produced according to the following scheme.

By taking the foregoing compounds as an example, the charge transport substance may be produced, for example, by the reaction of a compound having a formyl-containing triphenylamine skeleton with a phosphate compound having a triphenylamine skeleton (scheme 1). In this specification, Me, Et, and Bu represent methyl group, ethyl group, and butyl group, respectively.

### [Chem. 5]

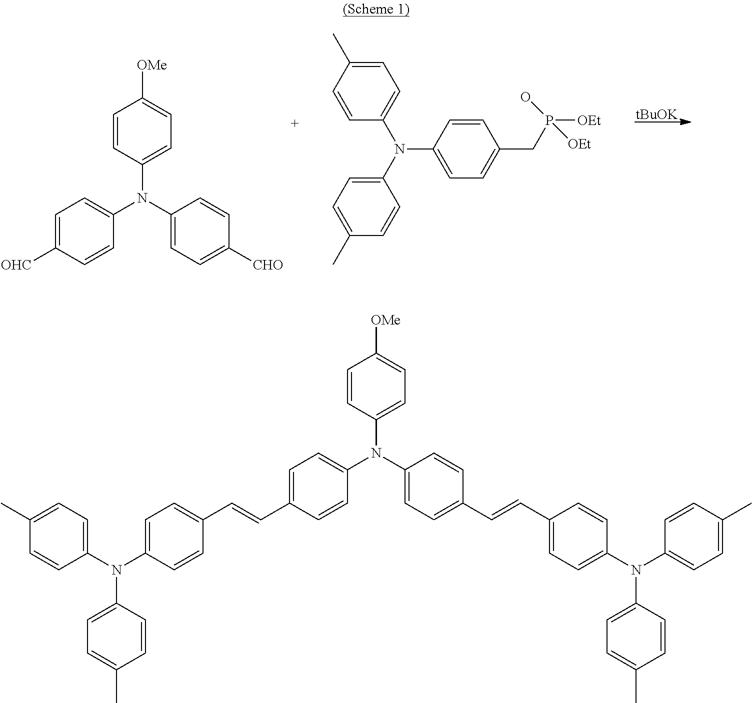

As an alternative process, the charge transport substance may also be produced by the coupling reaction of a halogen-containing triphenylamine derivative such as below with an aniline compound (scheme 2).

### [Chem. 6]

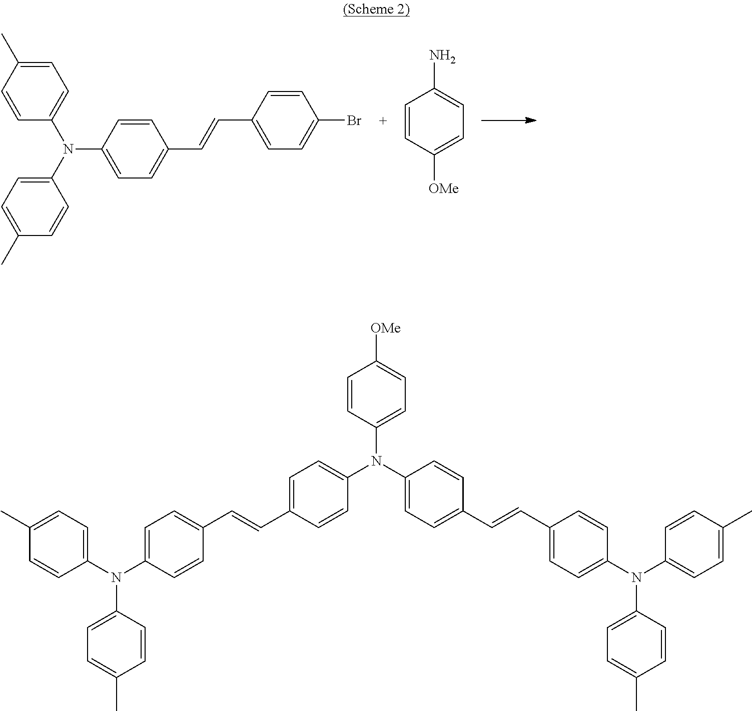

Preferably, the charge transport substance is a compound obtained by the coupling reaction of a halogen-containing triphenylamine derivative with an aniline compound. In this way, the charge transport substance can be synthesized with hardly any phosphorus compound that affects the charge transport, and the high yield of the reaction allows high electrical properties to be maintained when a polyester resin of poor electrical properties is used together.

The binder resin, and the compound (charge transport substance) of formula (1) contained in the photosensitive layer are used in such proportions that the charge transport substance in one or more layers forming the photosensitive layer is typically 5 mass parts or more with respect to 100 mass parts of the binder resin contained in the same layer. In terms of a residual electric potential drop, the proportion of the charge transport substance is preferably 10 mass parts or more, and is more preferably 15 mass parts or more in terms of reuse stability and charge mobility.

On the other hand, in terms of the heat stability of the photosensitive layer, the charge transport substance is used typically in 120 mass parts or less. The proportion of the charge transport substance is preferably 100 mass parts or less in terms of the compatibility between the charge transport material and the binder resin. In terms of heat resistance, the proportion of the charge transport substance is more preferably 90 mass parts or less. In terms of scratch resistance, the proportion of the charge transport substance is preferably 80 mass parts or less. It is particularly preferable in terms of abrasion resistance that the proportion of the charge transport substance is 50 mass parts or less.

The following are examples of the preferred structures of the charge transport substance of the present invention. The following structures are given for the purpose of more specifically describing the present invention, and do not limit the present invention in so long as they do not depart from the idea of the present invention.

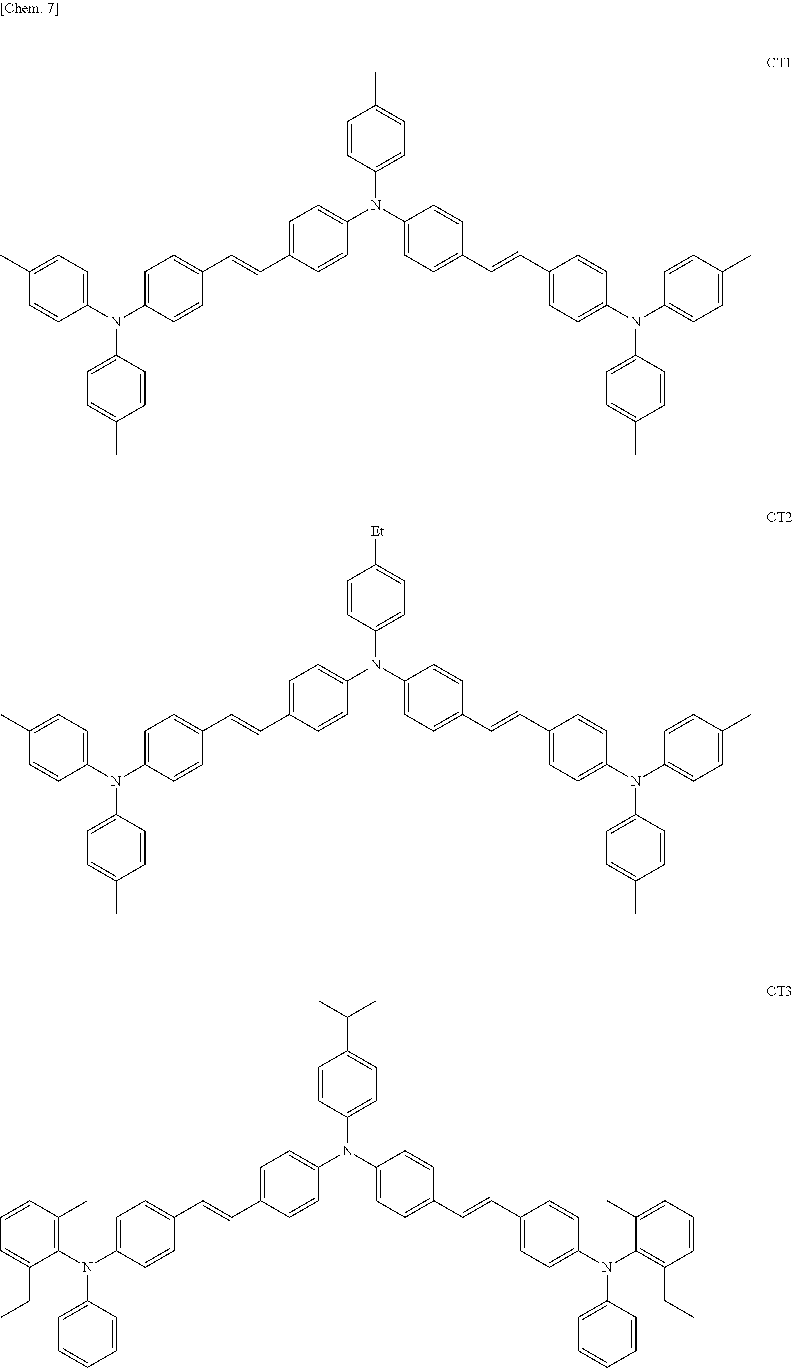

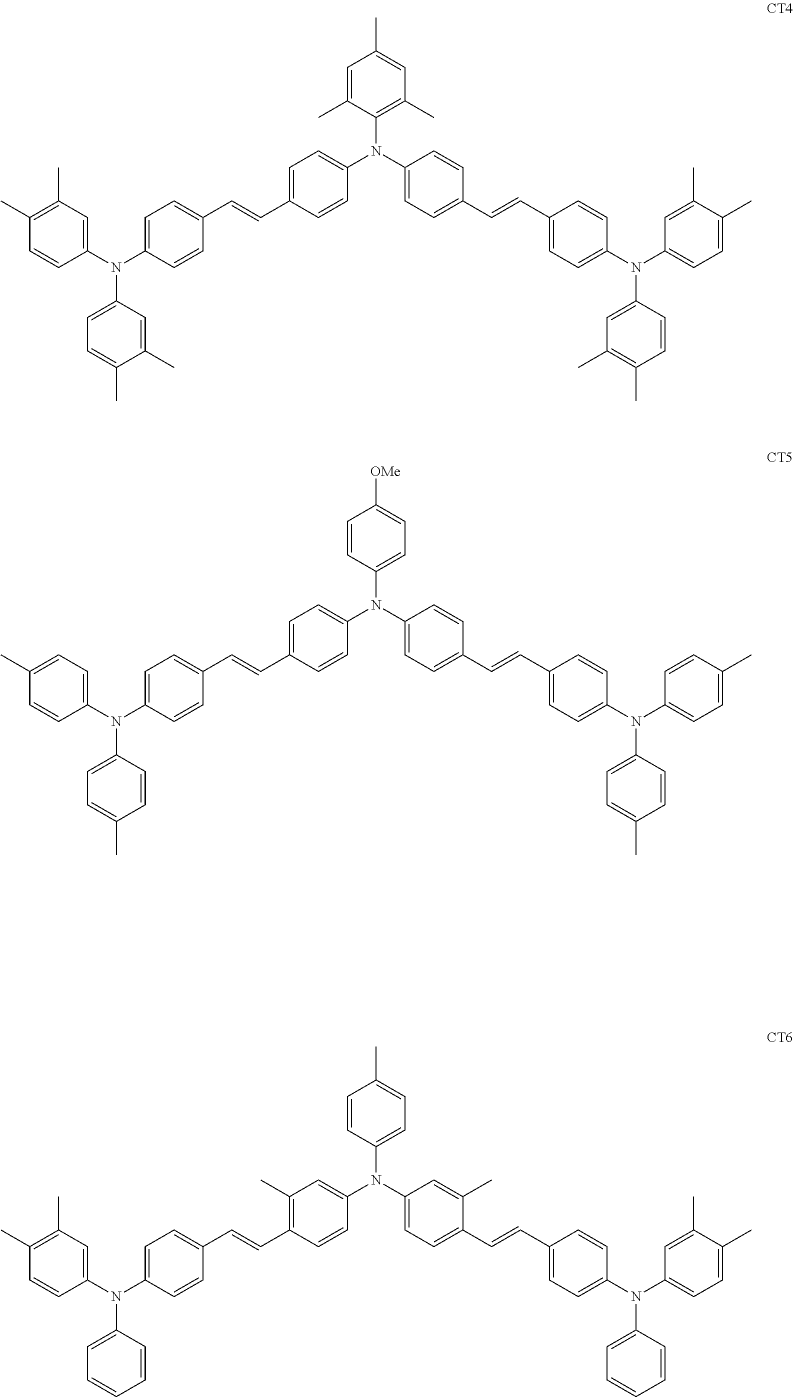

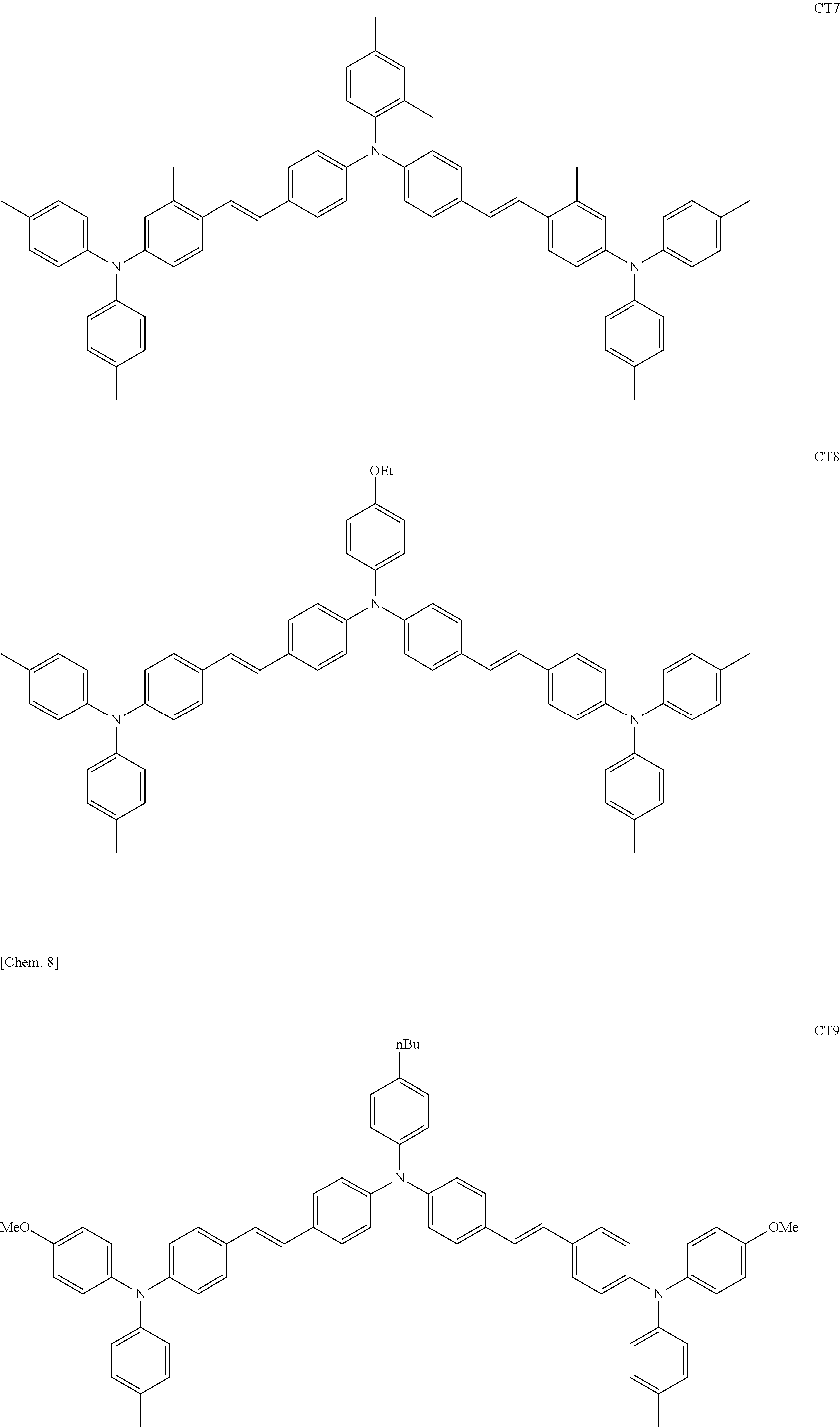

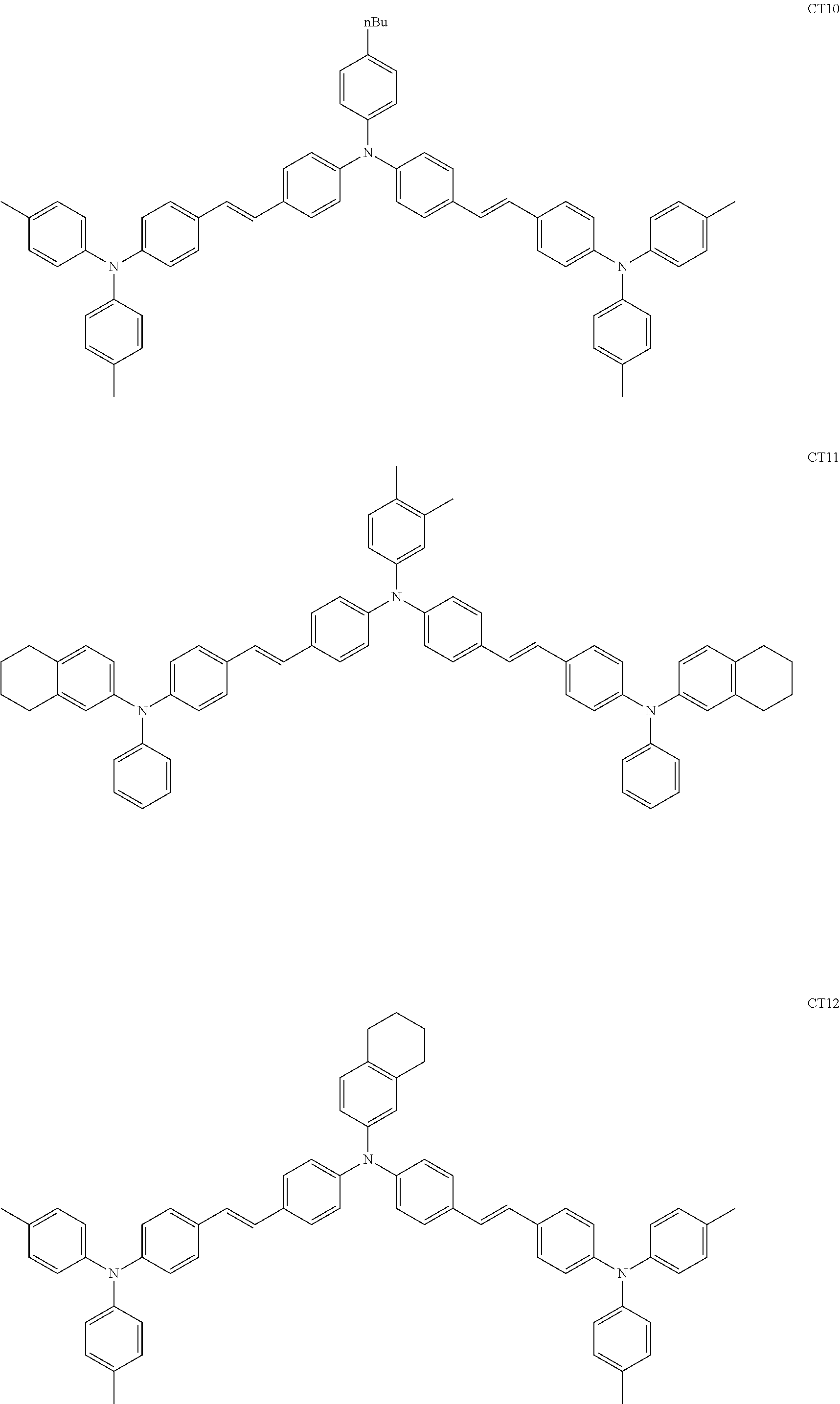

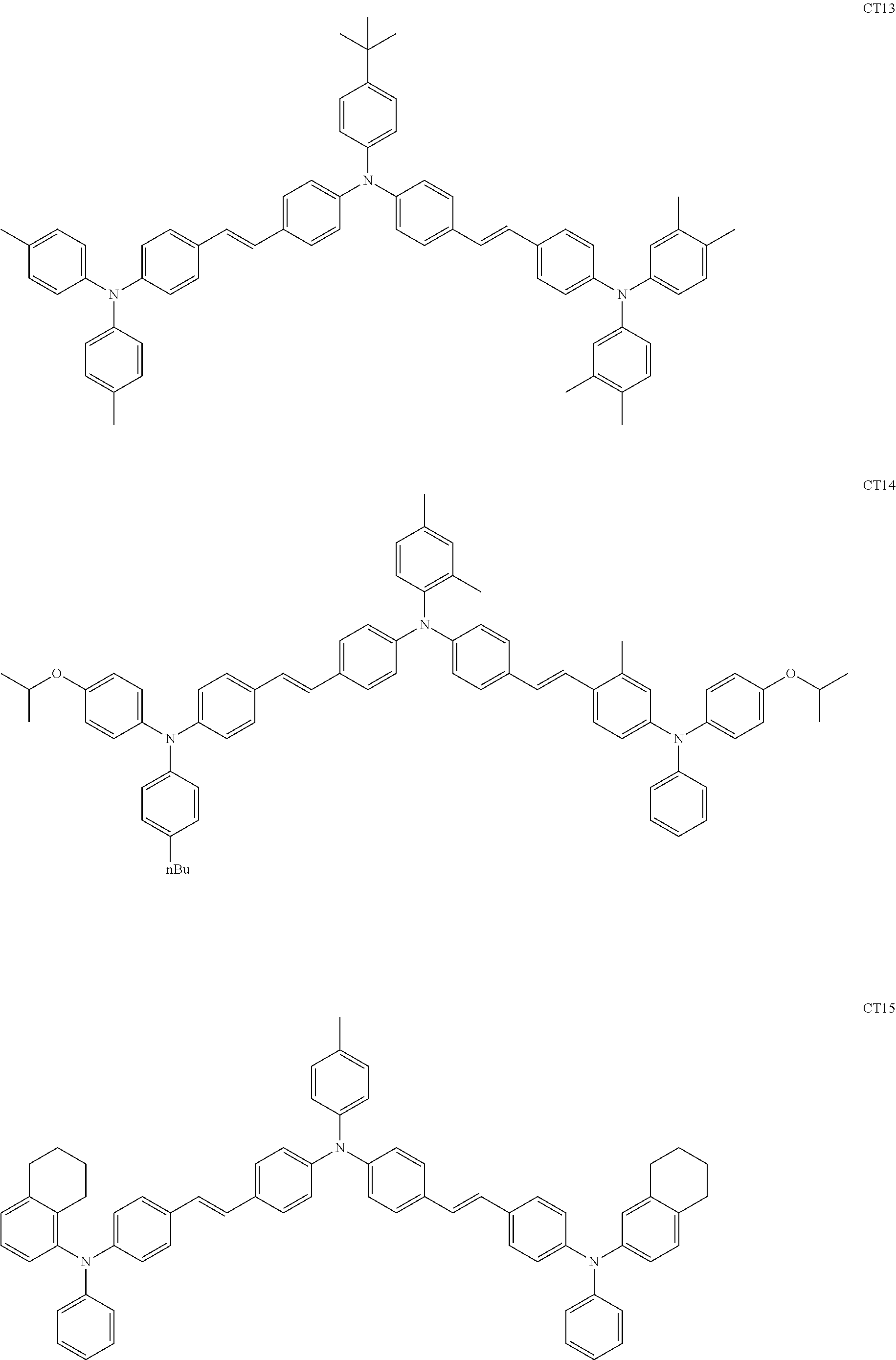

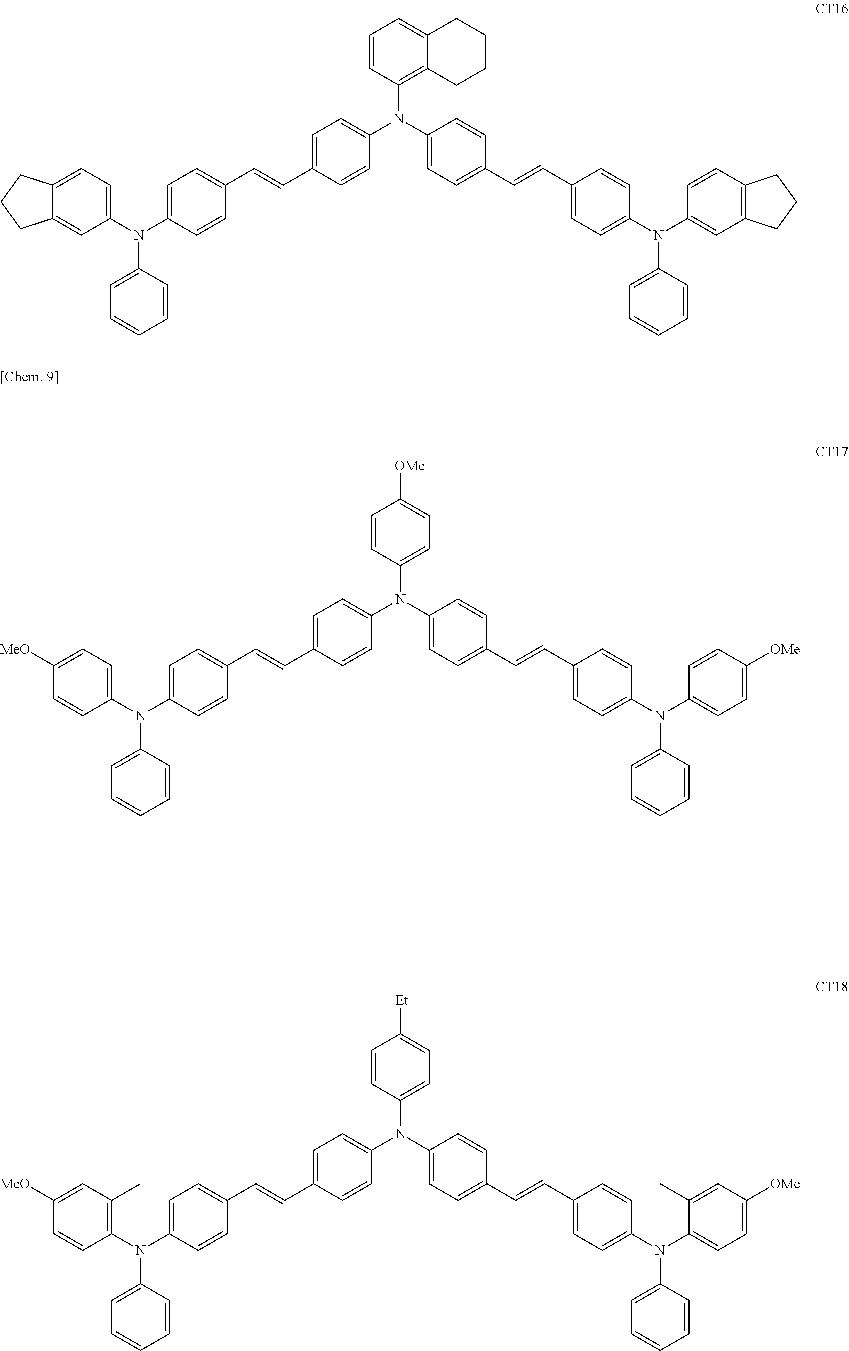 [SMILES: C(=C\c1ccc(N(c2ccc(/C=C/c3ccc(N(c4ccccc4)c4ccc5c(c4)CCC5)cc3)cc2)c2cccc3c2CCCC3)cc1)/c1ccc(N(c2ccccc2)c2ccc3c(c2)CCC3)cc1 ; COc1ccc(N(c2ccccc2)c2ccc(/C=C/c3ccc(N(c4ccc(/C=C/c5ccc(N(c6ccccc6)c6ccc(OC)cc6)cc5)cc4)c4ccc(OC)cc4)cc3)cc2)cc1 ; CCc1ccc(N(c2ccc(/C=C/c3ccc(N(c4ccccc4)c4ccc(OC)cc4C)cc3)cc2)c2ccc(/C=C/c3ccc(N(c4ccccc4)c4ccc(OC)cc4C)cc3)cc2)cc1]

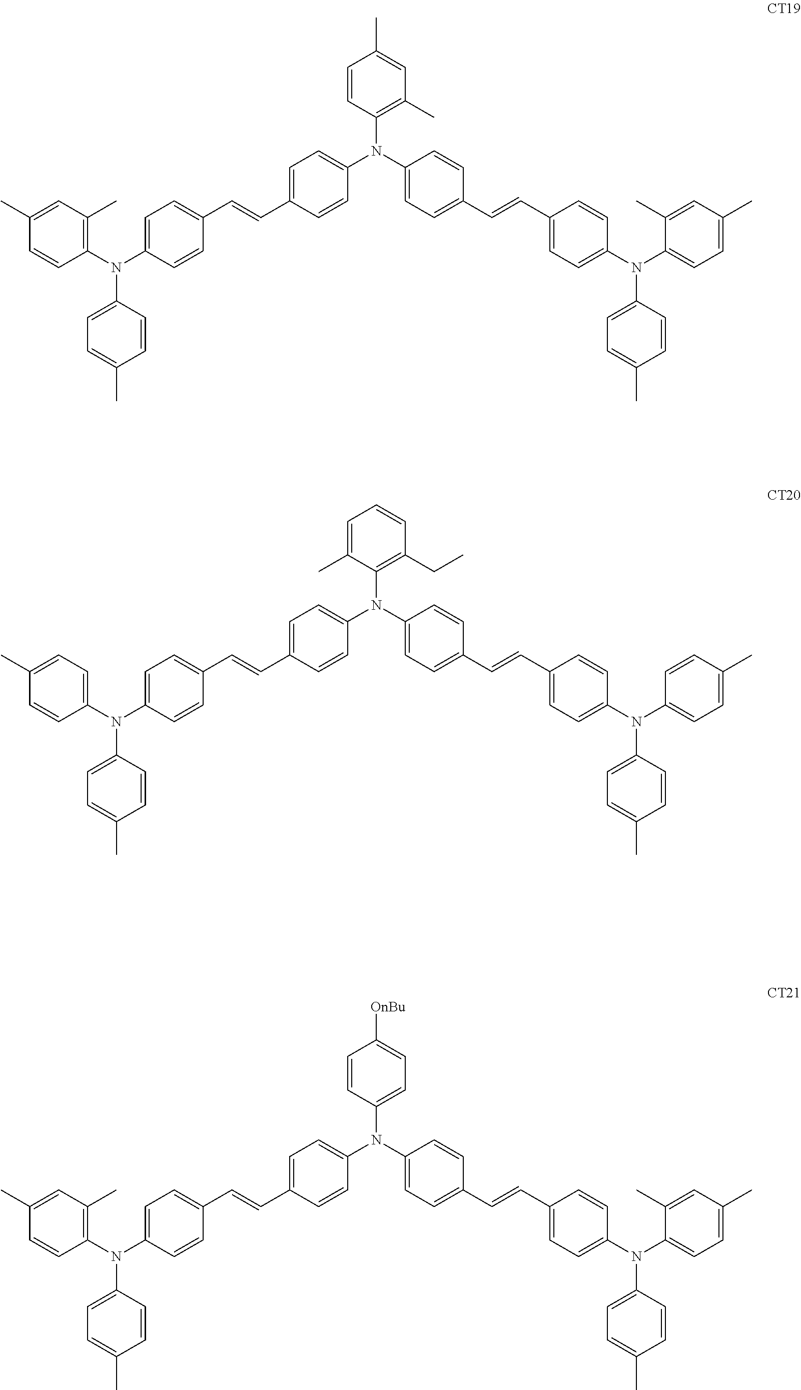

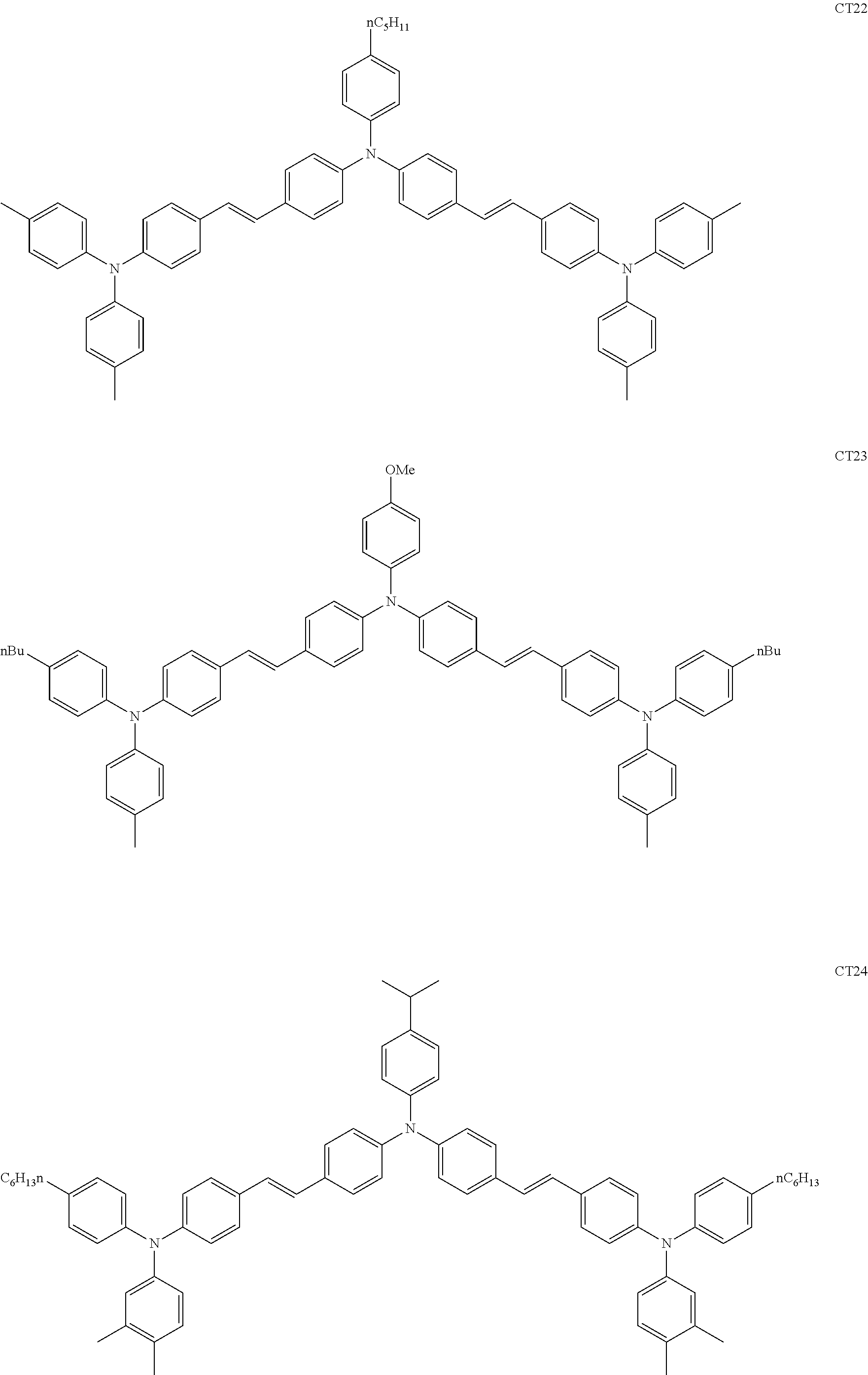

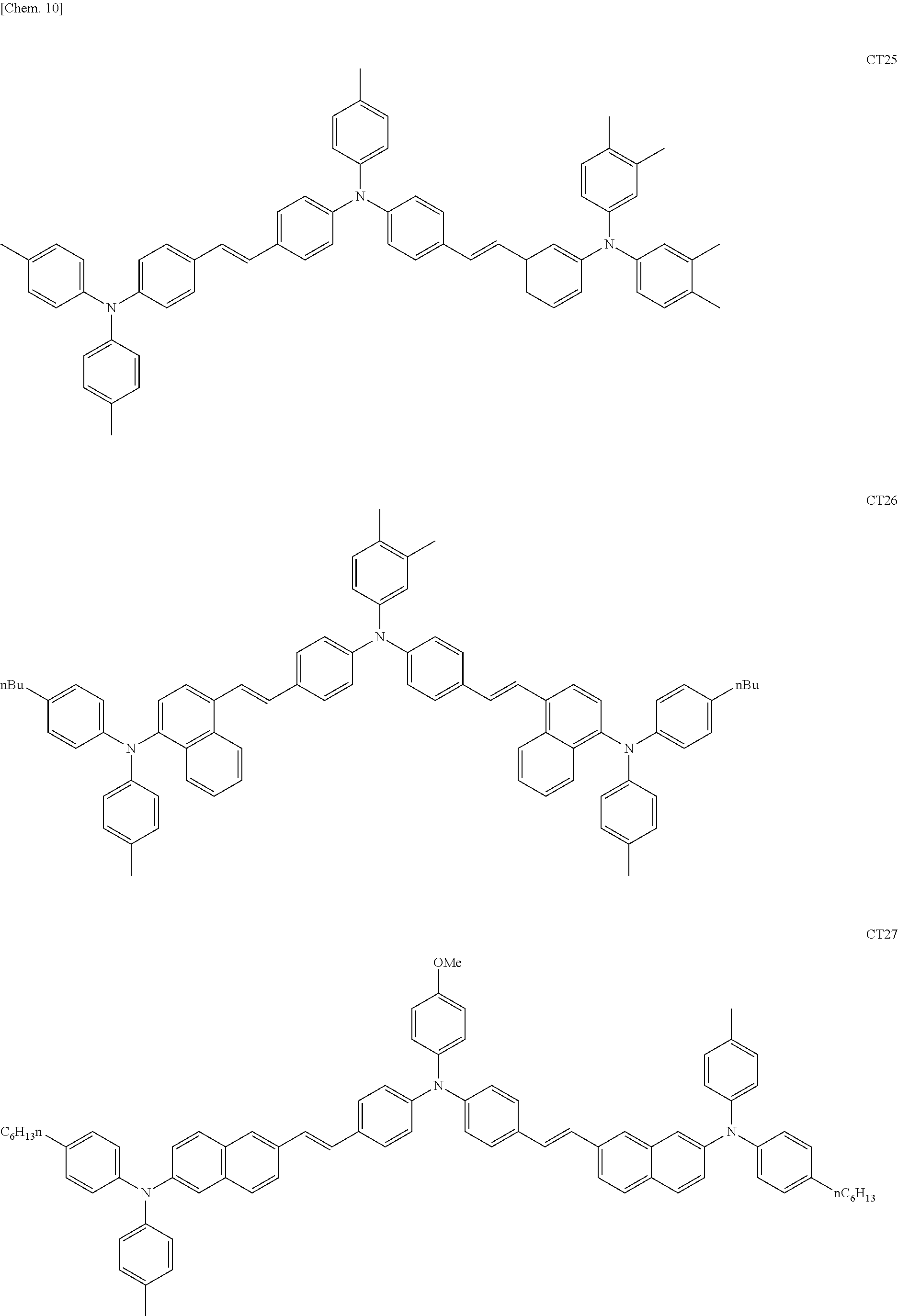

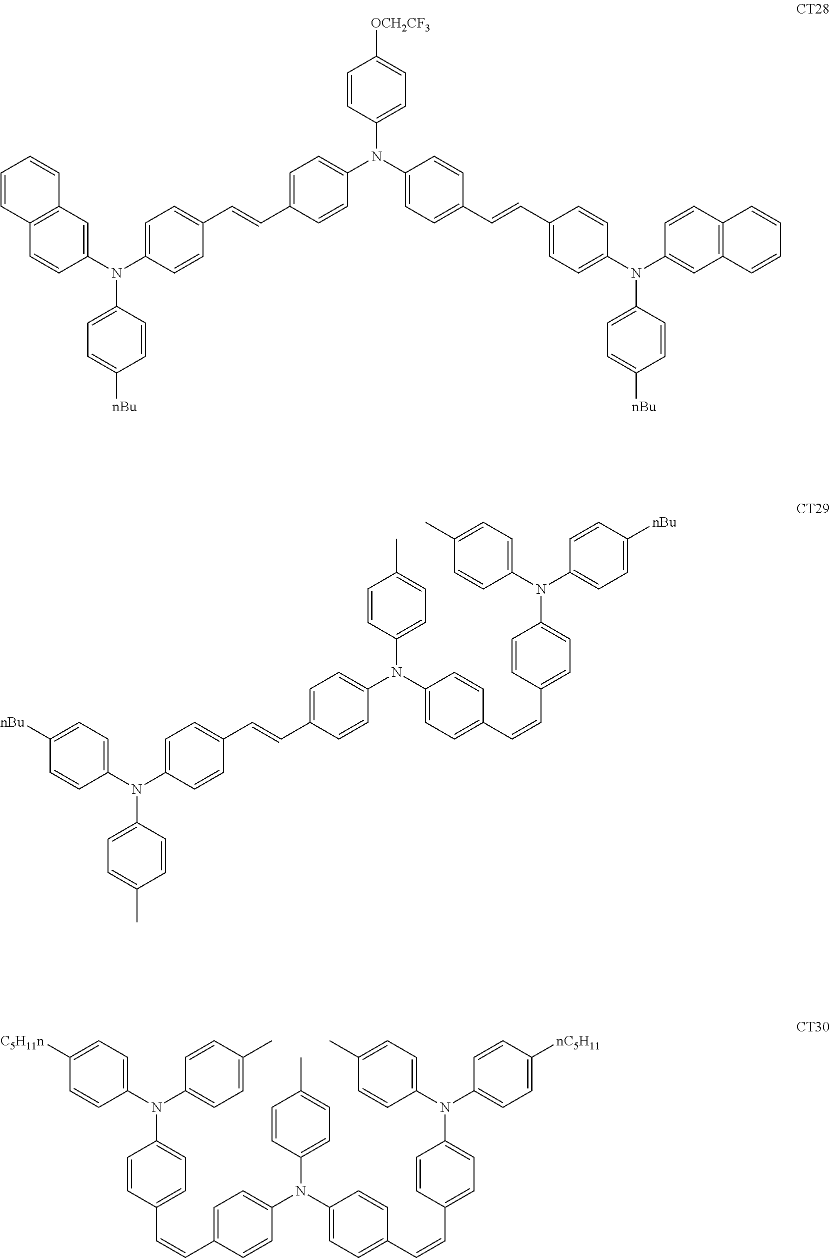

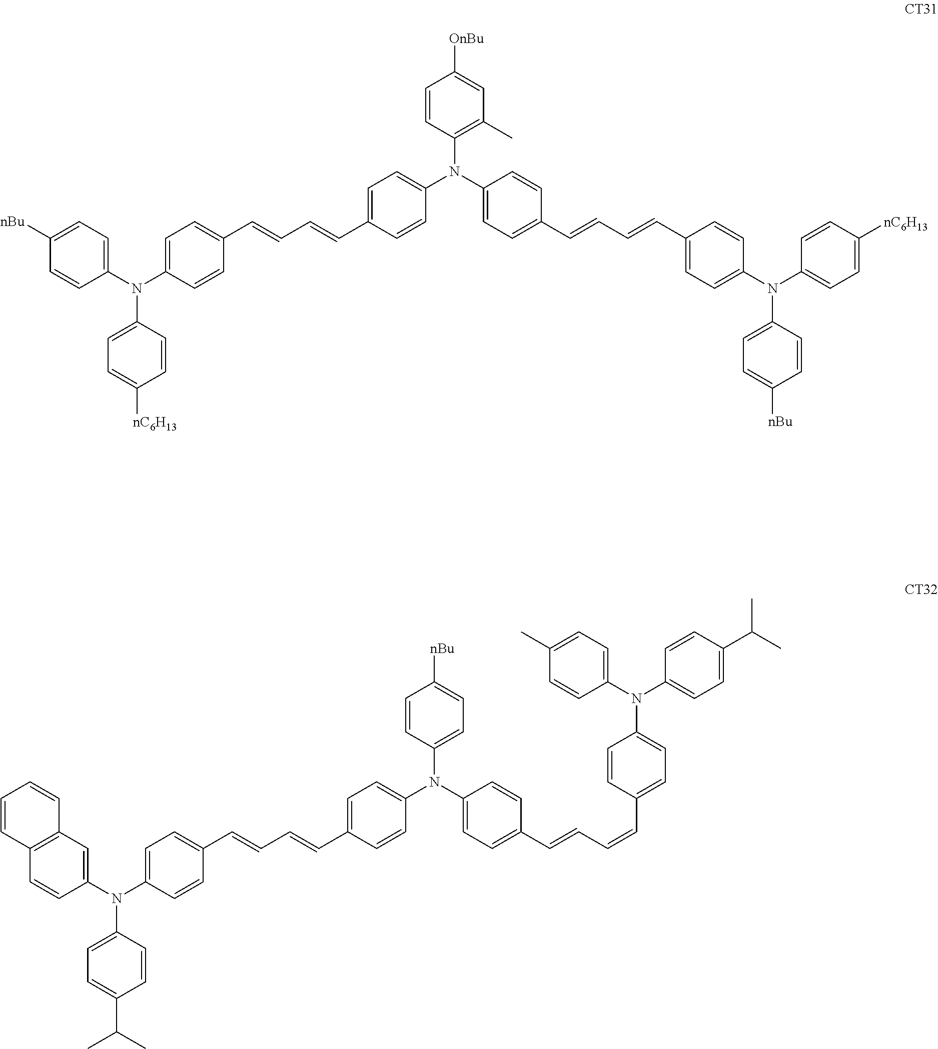

### Polyester Resin of the Present Invention

### Structure of Polyester Resin of the Present Invention

The polyester resin contained in the photosensitive layer of the present invention has the structure unit represented by the following formula (2).

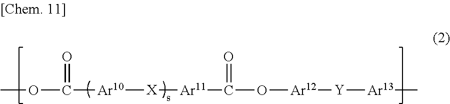

In formula (2), Ar¹⁰ to Ar¹³ each independently represent optionally substituted arylene group, X and Y each independently represent a single bond, an oxygen atom, a sulfur atom, or alkylene group, and s represents an integer of 0 to 2. When s is 2, a plurality of Ar¹⁰ s and Xs each may be the same or different.

In the formula (2), Ar¹⁰ to Ar¹³ each independently represent optionally substituted arylene group. The arylene has typically 6 or more carbon atoms, and typically 20 or less, preferably 10 or less, most preferably 6 carbon atoms. The electrical properties may suffer when the number of carbon atoms is excessive.

Specific examples of Ar¹⁰ to Ar¹³ include 1,2-phenylene group, 1,3-phenylene group, 1,4-phenylene group, naphthylene group, anthrylene group, and phenanthrylene group. In terms of electrical properties, the arylene group is preferably 1,4-phenylene group. The arylene group may be used alone, or two or more arylene groups may be used in any proportions and combinations.

Examples of the possible substituents of the Ar¹⁰ to Ar¹³ include alkyl group, aryl group, halogen, and alkoxy group. When polyester resin is used as the binder resin for the photosensitive layer, preferred as the substituents are alkyl group of 1 to 4 carbon atoms, aryl group of 6 to 12 carbon atoms, and alkoxy group of 1 to 4 carbon atoms, considering mechanical properties, and the solubility for the coating liquid used to form the photosensitive layer.

Specifically, preferred as the alkyl group are methyl group, ethyl group, propyl group, and isopropyl group. Preferred as the aryl group are phenyl group, and naphthyl group. Preferred as the alkoxy group are methoxy group, ethoxy group, propoxy group, and butoxy group.

More specifically, Ar¹² and Ar¹³ each independently have preferably 0 to 2 substituents. In terms of adhesion, Ar¹² and Ar¹³ more preferably have substituents. It is particularly preferable in terms of abrasion resistance that the number of substituent is 1. The substituent is preferably alkyl group, particularly preferably methyl group.

In terms of electrical properties and abrasion resistance, it is preferable that at least one of Ar¹² and Ar¹³ is alkyl group-containing arylene group when s in the formula (2) is 0.

On the other hand, Ar¹⁰ and Ar¹¹ each independently have preferably 0 to 2 substituents. More preferably, Ar¹⁰ and Ar¹¹ do not have substituents in terms of abrasion resistance.

In the formula (2), Y is a single bond, an oxygen atom, a sulfur atom, or alkylene group. The alkylene group is preferably —CH₂—, —CH(CH₃)—, —C(CH₃)₂—, or cyclohexylene group, more preferably —CH₂—, —CH(CH₃)—, or —C(CH₃)₂—.

In the formula (2), X is a single bond, an oxygen atom, a sulfur atom, or alkylene group, preferably an oxygen atom. In this case, s is preferably 0 or 1, particularly preferably 1.

Specific examples of the dicarboxylic acid residue preferred as the structure unit of formula (2) when s is 1 include a diphenylether-2,2′-dicarboxylic acid residue, a diphenylether-2,3′-dicarboxylic acid residue, a diphenylether-2,4′-dicarboxylic acid residue, a diphenylether-3,3′-dicarboxylic acid residue, a diphenylether-3,4′-dicarboxylic acid residue, and a diphenylether-4,4′-dicarboxylic acid residue. Considering the ease of production of the dicarboxylic acid component, the dicarboxylic acid residue is more preferably a diphenylether-2,2′-dicarboxylic acid residue, a diphenylether-2,4′-dicarboxylic acid residue, or a diphenylether-4,4′-dicarboxylic acid residue, particularly preferably a diphenylether-4,4′-dicarboxylic acid residue.

Specific examples of the dicarboxylic acid residue when s is 0 include a phthalic acid residue, an isophthalic acid residue, a terephthalic acid residue, a toluene-2,5-dicarboxylic acid residue, a p-xylene-2,5-dicarboxylic acid residue, a naphthalene-1,4-dicarboxylic acid residue, a naphthalene-2,3-dicarboxylic acid residue, a naphthalene-2,6-dicarboxylic acid residue, a biphenyl-2,2′-dicarboxylic acid residue, and a biphenyl-4,4′-dicarboxylic acid residue, preferably a phthalic acid residue, an isophthalic acid residue, a terephthalic acid residue, a naphthalene-1,4-dicarboxylic acid residue, a naphthalene-2,6-dicarboxylic acid residue, a biphenyl-2,2′-dicarboxylic acid residue, and a biphenyl-4,4′-dicarboxylic acid residue, particularly preferably an isophthalic acid residue, and a terephthalic acid residue. These dicarboxylic acid residues may be used in a combination of two or more.

Preferred specific examples include a polyallylate resin having the structure unit represented by the formula (3) or (4) below. In the formulae (3) and (4), the proportions of the isophthalic acid residue and the terephthalic acid residue are typically 50:50; however, these may be used in any proportions. A higher terephthalic acid residue proportion is preferred in terms of electrical properties.

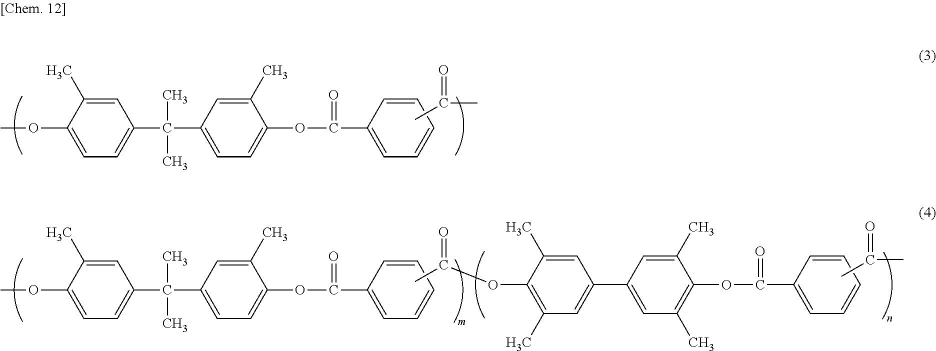

The polyester resin used in the present invention may have any viscosity average molecular weight, as long as it is not detrimental to the advantages of the present invention. However, the viscosity average molecular weight is preferably 20,000 or more, more preferably 30,000 or more, and preferably 90,000 or less, more preferably 80,000 or less.

The mechanical strength of the polyester resin may become insufficient when the viscosity average molecular weight value is too small. When too large, the viscosity of the coating liquid used to form the photosensitive layer becomes excessively high, and productivity may suffer. Viscosity average molecular weight may be measured by using the method described in Examples, using, for example, an Ubbelohde capillary viscometer.

The polyester resin having the structure unit represented by the formula (2) of the present invention is contained in the layer at the outermost surface of the electrophotographic photoreceptor having a photosensitive layer on an electrocondutive support. However, the polyester resin is contained in a protective layer when a protective layer is formed on the photosensitive layer, as will be described later in detail.

### Electrophotographic Photoreceptor

The configuration of the electrophotographic photoreceptor of the present invention is described below.

The structure of the electrophotographic photoreceptor of the present invention is not particularly limited, as long as the photosensitive layer containing the charge transport substance of formula (1) and the polyester resin having the structure unit represented by formula (2) is provided on an electrocondutive support. The polyester resin is used primarily as the binder resin.

When the photosensitive layer of the electrophotographic photoreceptor is a laminated layer (described later), the charge transport layer contains the charge transport substance of the formula (1), the polyester resin having the structure unit of formula (2), and, optionally, additives such as an antioxidant, and a leveling agent.

When the photosensitive layer of the electrophotographic photoreceptor is a monolayer (described later), a charge generating material and an electron transport material are typically used in addition to the components used for the charge transport layer of the laminated photoreceptor.

### Electrocondutive Support

The electrocondutive support in the electrophotographic photoreceptor according to the present invention is not particularly limited, and is typically, for example, a metallic material such as aluminum, an aluminum alloy, stainless steel, copper, and nickel; a resin material that is made conductive by adding a conductive powder such as metal, carbon, and tin oxide; or resin, glass, paper, or other such material used after the surface vapor deposition or application of, for example, a conductive material such as aluminum, nickel, and ITO (indium tin oxide). These may be used alone, or two or more materials may be used in any combinations and proportions.

The electrocondutive support may have a form of, for example, a drum, a sheet, or a belt. The metallic electrocondutive support may be used after being coated with a conductive material having an appropriate resistance value in order to control properties such as conductivity and surface property, and to cover any defect.

When metallic materials such as an aluminum alloy is used for the electrocondutive support, the electrocondutive support may be used after being anodized. Anodization desirably involves a sealing process by a known method.

The electrocondutive support may have a smooth surface, or the surface may be roughened by using a special cutting technique, or by grinding. Particles of a suitable particle size may be mixed in the material of the electrocondutive support to provide a rough surface. To save cost, a drawn tube may directly be used without cutting.

### Underlayer

An underlayer may be provided between the electrocondutive support and the photosensitive layer (described later) to improve properties such as adhesion and blocking. The underlayer is, for example, a resin, or a particle-dispersed resin containing particles such as metal oxide. The underlayer may be a single layer, or a plurality of layers.

Examples of the metal oxide particles used for the underlayer include metal oxide particles containing one kind of metallic element, for example, such as titanium oxide, aluminum oxide, silicon oxide, zirconium oxide, zinc oxide, and iron oxide; and metal oxide particles containing more than one kind of metallic element, for example, such as calcium titanate, strontium titanate, and barium titanate. These particles may be used either alone or as a mixture of different particles. Preferred as the metal oxide particles are titanium oxide and aluminum oxide, particularly preferably titanium oxide.

The titanium oxide particles may be surface treated with inorganic materials such as tin oxide, aluminum oxide, antimony oxide, zirconium oxide, and silicon oxide, or with organic materials such as stearic acid, polyol, and silicon. The crystal form of the titanium oxide particles may be any of rutile, anatase, brookite, and amorphous. The titanium oxide particles may have more than one crystalline state.

The metal oxide particles may have various particle sizes. In terms of properties and liquid stability, the average primary particle size is preferably 10 nm to 100 nm, particularly preferably 10 nm to 50 nm. The average primary particle size may be obtained from a TEM micrograph or the like.

Desirably, the underlayer is formed as a dispersion of metal oxide particles in a binder resin.

Examples of the binder resin used for the underlayer include various known binder resins, for example, such as epoxy resin, polyethylene resin, polypropylene resin, acrylic resin, methacrylic resin, polyamide resin, vinyl chloride resin, vinyl acetate resin, phenolic resin, polycarbonate resin, polyurethane resin, polyimide resin, vinylidene chloride resin, polyvinyl acetal resin, a vinyl chloride-vinyl acetate copolymer, polyvinyl alcohol resin, polyurethane resin, polyacrylic resin, polyacrylamide resin, polyvinyl pyrrolidone resin, polyvinyl pyridine resin, water-soluble polyester resin, cellulose ester resin (such as nitrocellulose), cellulose ether resin, casein, gelatin, polyglutamic acid, starch, starch acetate, amino starch, organic zirconium compounds (such as a zirconium chelate compound, and a zirconium alkoxide compound), organic titanyl compounds (such as a titanyl chelate compound, and a titanium alkoxide compound), and a silane coupling agent. These may be used alone, or two or more resins may be used in any combinations and proportions. These may also be used in a cured form with a curing agent. Alcohol soluble copolymerized polyamides, and modified polyamides are preferred for their desirable dispersibility, and coatability.

The inorganic particles used for the underlayer may be used in any proportion. In terms of dispersion stability and coatability, the inorganic particles are preferably used typically in 10 mass % to 500 mass % with respect to the binder resin.

The underlayer may have any thickness, as long as it is not detrimental to the advantages of the present invention. However, the underlayer thickness is typically 0.01 μm or more, preferably 0.1 μm or more, and typically 30 μm or less, preferably 20 μm or less in terms of the electrical properties of the electrophotographic photoreceptor, the strength of exposure characteristics, image characteristics, repeatability, and coatability in production.

A known antioxidant or the like may be mixed in the underlayer. The underlayer may also contain pigment particles, resin particles, or the like to prevent image defects or other deficiencies.

### Photosensitive Layer

The photosensitive layer is formed on the electrocondutive support (on the underlayer when the underlayer is provided). The photosensitive layer is a layer containing the charge transport substance represented by the formula (1), and the polyester resin having the structure unit represented by formula (2).

The photosensitive layer may have any form, for example, a form of a monolayer structure in which a charge generating material and a charge transport substance (including the charge transport substance of the present invention) exist in the same layer by being dispersed in a binder resin (hereinafter referred to as “monolayer photosensitive layer” as appropriate), or a form of a functionally separated laminate of two or more layers including a charge generating layer in which a charge generating material is dispersed in a binder resin, and a charge transport layer in which a charge transport substance (including the charge transport substance of the present invention) is dispersed in a binder resin (hereinafter referred to as “laminated photosensitive layer”, as appropriate). The photosensitive layer may be provided with a protective layer.

The laminated photosensitive layer may be a forward laminated photosensitive layer in which the charge generating layer and the charge transport layer are laminated in this order from the electrocondutive support side, or a reverse laminated photosensitive layer in which the charge transport layer and the charge generating layer are laminated in this order from the electrocondutive support side. However, the forward laminated photosensitive layer is more preferred for its ability to exhibit balanced photoconduction.

### Laminated Photosensitive Layer

### Charge Generating Layer

The charge generating layer of the laminated photosensitive layer (functionally separated photosensitive layer) contains the charge generating material (hereinafter, also referred to as “charge generating substance”), typically with a binder resin, and optional other components. Such a charge generating layer can be obtained, for example, by dissolving or dispersing the charge generating material and the binder resin in a solvent or a dispersion medium to produce a coating liquid, and applying and drying the coating liquid on the electrocondutive support in the case of a forward laminated photosensitive layer (on the underlayer when the underlayer is provided), or on the charge transport layer in the case of the reverse laminated photosensitive layer.

Examples of the charge generating substance include inorganic photoconductive materials such as selenium and an alloy thereof, and cadmium sulfide; and organic photoconductive materials such as organic pigments. Organic photoconductive materials are more preferred, and organic pigments are particularly preferred.

Examples of the organic pigments include phthalocyanine pigments, azo pigments, dithioketopyrrolopyrrole pigments, squalene (squarylium) pigments, quinacridone pigments, indigo pigments, perylene pigments, polycyclic quinone pigments, anthanthrone pigments, and benzimidazole pigments. Particularly preferred are phthalocyanine pigments and azo pigments.

When an organic pigment is used as the charge generating substance, the organic pigment is typically used in the form of a disperse layer in which organic pigment fine particles are bound to each other with various binder resins.

When a phthalocyanine pigment is used as the charge generating substance, specific examples of the phthalocyanine pigment include metal-free phthalocyanines; phthalocyanines of various crystal forms coordinated with metals such as copper, indium, gallium, tin, titanium, zinc, vanadium, silicon, germanium, aluminum, or oxide thereof, halide, hydroxide, and alkoxide; and phthalocyanine dimers that use oxygen atoms or the like as crosslinking atoms.

Particularly preferred are metal-free phthalocyanines of X, τ crystal forms with high sensitivity; A-form (also called β), B-form (also called α), and D-form (also called Y) titanyl phthalocyanines (also known as oxytitanium phthalocyanine); vanadyl phthalocyanine; chloroindium phthalocyanine; hydroxyindium phthalocyanine; chlorogallium phthalocyanine of form II or other forms; hydroxygallium phthalocyanine of form V or other forms; μ-oxo-gallium phthalocyanine dimers of form G, I, and other forms; and μ-oxo-aluminum phthalocyanine dimers of form II or other forms.

Particularly preferred among these phthalocyanines are A-form (also called β) and B-form (also called α) titanyl phthalocyanines; D-form (Y) titanyl phthalocyanine that shows a clear peak at a powder X-ray diffraction angle 20 (±0.2°) of 27.1° or 27.3°; form-II chlorogallium phthalocyanine; form-V hydroxygallium phthalocyanine; hydroxygallium phthalocyanine that has the highest peak at 28.1°; hydroxygallium phthalocyanine that does not have a peak at 26.2° but has a clear peak at 28.1° and a half bandwidth W of 0.1°≦W≦0.4° at 25.9°; and form-G phthalocyanine dimer.

Preferably, oxytitanium phthalocyanine crystals are crystals having major peaks at a Bragg angle (2θ±0.2°) of 24.1° and 27.2° for a CuKα characteristic X-ray (wavelength 1.541 Å). It is not preferable to have peaks in the vicinity of 26.2° because crystals having diffraction peaks in the vicinity of 26.2° are inferior in terms of dispersion crystallization stability. More preferred in terms of a dark decay and residual electric potential in use as an electrophotographic photoreceptor are crystals having major diffraction peaks at 7.3°, 9.6°, 11.6°, 14.2°, 18.0°, 24.1°, and 27.2°, or at 7.3°, 9.5°, 9.7°, 11.6°, 14.2°, 18.0°, 24.2°, and 27.2°.

When a metal-free phthalocyanine compound, or a metal-containing phthalocyanine compound is used as the charge generating substance, a photoreceptor can be obtained that has high sensitivity for laser beams of relatively longer wavelengths, for example, in the vicinity of 780 nm.

When azo pigments such as monoazo, diazo, and trisazo pigments are used, a photoreceptor can be obtained that has sufficient sensitivity for white light, laser beams of wavelengths in the vicinity of 660 nm, or laser beams of relatively short wavelengths (for example, 380 nm to 500 nm wavelengths).

The phthalocyanine compound may be a single compound, or more than one phthalocyanine compound may be used as a mixture or in a mixed crystal state. The mixed state (mixed crystal state) of phthalocyanine compounds or crystal states may be one obtained by mixing the constituting elements afterwards, or may be one that occurs in the production and processing of phthalocyanine compounds such as by synthesis, pigmentation, and crystallization.

Acid pasting, milling, and solvent treatment represent known examples of such processes. A mixed crystal state may be obtained by using the method described in, for example, JP-A-10-48859, in which two crystals are mixed, mechanically milled into irregular shapes, and converted into a specific crystal state by solvent treatment.

When an azo pigment is used as the charge generating material, various known azo pigments such as above may be used, provided that these are sensitive to the light-input light source. However, preferred for use are bisazo pigments, and trisazo pigments. The following are examples of the preferred azo pigments.

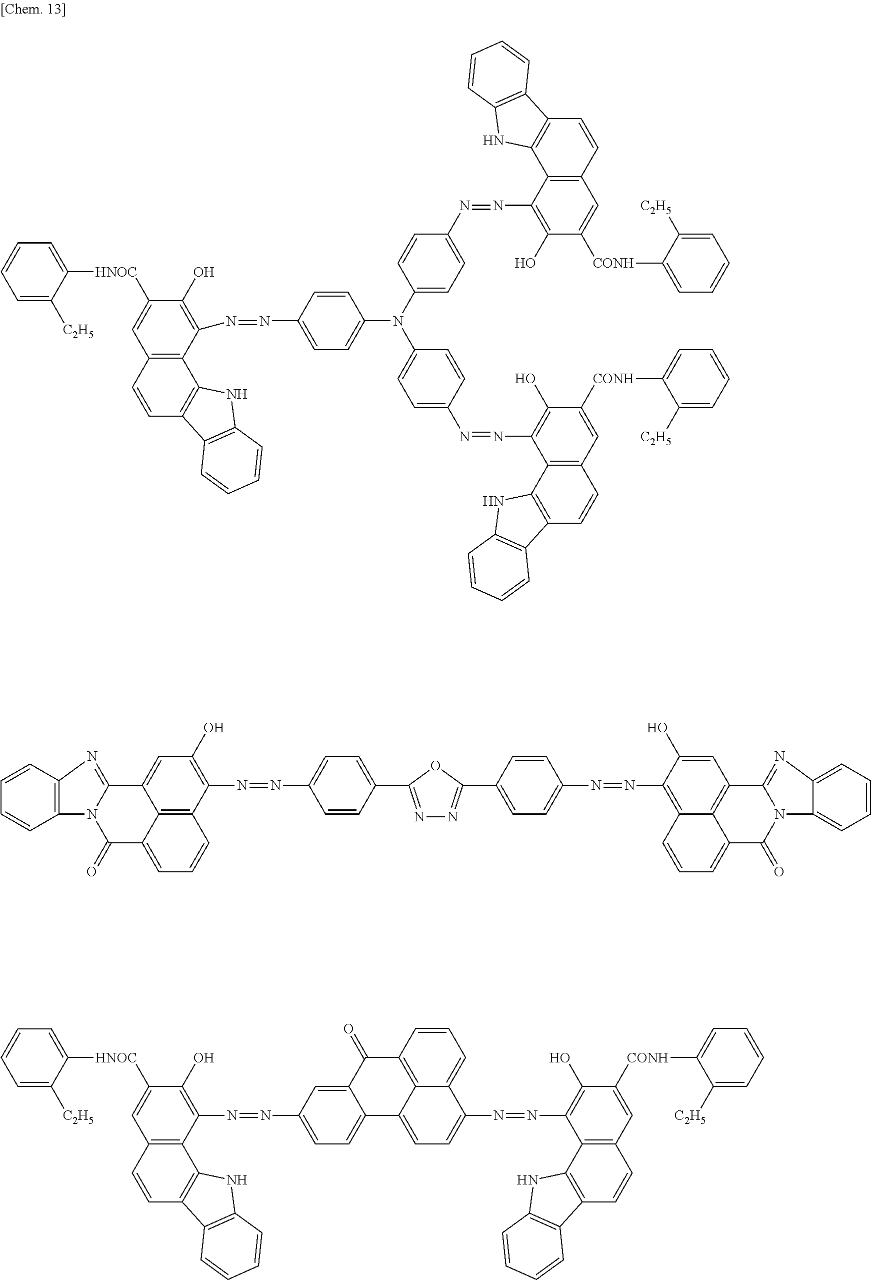

The organic pigment used as the charge generating substance may be used either alone or as a mixture of two or more. In the case of a mixture, it is preferable to use a combination of two or more charge generating substances having spectral sensitivity characteristics in two different spectrum regions, the visible region and the near-infrared region, more preferably a combination of a disazo pigment, a trisazo pigment, and a phthalocyanine pigment.

The binder resin used for the charge generating layer forming the laminated photosensitive layer is not particularly limited. Examples include insulating resins such as polyvinyl acetal resins (such as polyvinyl butyral resin, polyvinyl formal resin, and partially acetalized polyvinyl butyral resin in which the butyral is partially modified with formal or acetal), polyallylate resin, polycarbonate resin, polyester resin, modified ether polyester resin, phenoxy resin, polyvinyl chloride resin, polyvinylidene chloride resin, polyvinyl acetate resin, polystyrene resin, acrylic resin, methacrylic resin, polyacrylamide resin, polyamide resin, polyvinyl pyridine resin, cellulose resin, polyurethane resin, epoxy resin, silicone resin, polyvinyl alcohol resin, polyvinyl pyrrolidone resin, casein, vinyl chloride/vinyl acetate-containing copolymers (such as a vinyl chloride-vinyl acetate copolymer, a hydroxy modified vinyl chloride-vinyl acetate copolymer, a carboxyl modified vinyl chloride-vinyl acetate copolymer, and a vinyl chloride-vinyl acetate-maleic acid anhydride copolymer), styrene-butadiene copolymer, vinylidene chloride-acrylonitrile copolymer, styrene-alkyd resin, silicon-alkyd resin, and phenol-formaldehyde resin; and organic photoconductive polymers such as poly-N-vinylcarbazole, polyvinylanthracene, and polyvinylperylene. These binder resins may be used either alone or as a mixture of any combinations of two or more.

The charge generating layer is formed specifically by dispersing the charge generating substance in a solution of a binder resin dissolved in an organic solvent, and applying the resulting coating liquid onto the electrocondutive support (on the underlayer when the underlayer is provided).

The solvent used for the production of the coating liquid is not particularly limited, as long as it can dissolve the binder resin. Examples include saturated aliphatic solvents such as pentane, hexane, octane, and nonane; aromatic solvents such as toluene, xylene, and anisole; halogenated aromatic solvents such as chlorobenzene, dichlorobenzene, and chloronaphthalene; amide solvents such as dimethylformamide, and N-methyl-2-pyrrolidone; alcohol solvents such as methanol, ethanol, isopropanol, n-butanol, and benzyl alcohol; aliphatic polyalcohols such as glycerine, and polyethylene glycol; chain or cyclic ketone solvents such as acetone, cyclohexanone, methyl ethyl ketone, and 4-methoxy-4-methyl-2-pentanone; ester solvents such as methyl formate, ethyl acetate, and n-butyl acetate; halogenated hydrocarbon solvents such as methylene chloride, chloroform, and 1,2-dichloroethane; chain or cyclic ether solvents such as diethyl ether, dimethoxyethane, tetrahydrofuran, 1,4-dioxane, methyl cellosolve, and ethyl cellosolve; nonprotonic polar solvents such as acetonitrile, dimethyl sulfoxide, sulfolane, hexamethylphosphoric triamide; nitrogen-containing compounds such as n-butylamine, isopropanolamine, diethylamine, triethanolamine, ethylenediamine, triethylenediamine, and triethylamine; mineral oil such as ligroin; and water. These may be used either alone or in a combination of two or more. Preferably, the solvent used does not dissolve the underlayer when the underlayer is provided.

The mixture ratio (mass ratio) of the binder resin and the charge generating substance in the charge generating layer is such that the charge generating substance is typically 10 mass parts or more, preferably 30 mass parts or more, and typically 1000 mass parts or less, preferably 500 mass parts or less with respect to 100 mass parts of the binder resin. The charge generating substance may aggregate, and the coating liquid stability may suffer when the proportion of the charge generating substance is too high. An excessively low proportion of the charge generating substance may lower the sensitivity of the photoreceptor.

The thickness of the charge generating layer is typically 0.1 μm or more, preferably 0.15 μm or more, and typically 10 μm or less, preferably 0.6 μm or less.

The charge generating substance may be dispersed by using known methods such as a ball mill dispersing method, an attritor dispersing method, and a sand mill dispersing method. It is effective to reduce the particle size to 0.5 μm or less, preferably 0.3 μm or less, more preferably 0.15 μm or less.

### Charge Transport Layer

The charge transport layer of the laminated photoreceptor contains the charge transport substance, a binder resin, and optional other components. Such a charge transport layer may be obtained specifically by dissolving or dispersing materials such as the charge transport substance and a binder resin in a solvent, and applying and drying the resulting coating liquid on the charge generating layer in the case of the forward laminated photosensitive layer, or on the electrocondutive support in the case of the reverse laminated photosensitive layer (on the underlayer when the underlayer is provided).

The charge transport substance is preferably the charge transport substance represented by the formula (1). Other known charge transport substances may be used with the charge transport substance represented by the formula (1). When using other charge transport substances, the type of charge transport substance is not particularly limited. Preferred examples include carbazole derivatives, hydrazone compounds, aromatic amine derivatives, enamine derivatives, butadiene derivatives, and materials in which derivatives of these are bound to each other. These charge transport substances may be used either alone or in any combination of two or more.

In order for the charge transport substance of the present invention to exhibit effect, the proportion of the charge transport substance of formula (1) of the present invention is typically 10 mass % or more, preferably 30 mass % or more in terms of the light attenuation characteristics of the electrophotographic photoreceptor, more preferably 50 mass % or more in terms of increasing the response of the electrophotographic photoreceptor, further preferably 70 mass % or more, particularly preferably 100 mass % with respect to the total charge transport substance.

The polyester resin represented by the formula (2) is used as the binder resin. The polyester resin represented by formula (2) may be used alone, or may be used by being mixed with other resins, provided that the function of the polyester resin remains intact. Examples of such other binder resins include polymers and copolymers of vinyl compounds such as butadiene resin, styrene resin, vinyl acetate resin, vinyl chloride resin, acrylic acid ester resin, methacrylic acid ester resin, vinyl alcohol resin, and ethyl vinyl ether. Other examples include polyvinyl butyral resin, polyvinyl formal resin, partially modified polyvinyl acetal, polycarbonate resin, polyamide resin, polyurethane resin, cellulose ester resin, phenoxy resin, silicon resin, silicon-alkyd resin, and poly-N-vinyl carbazole resin. Preferred is polycarbonate resin. These binder resins may be used by being crosslinked under, for example, heat or light with a suitable curing agent.

The charge transport substance represented by the formula (1) of this patent application shows sufficient and desirable electrical properties even when used in small amounts with respect to 100 mass parts of the polyester resin. Presumably, this is because of the small uneven charge distribution within the molecule, and the elongated molecule conjugate system, smoothly moving the charges within the molecule and increasing the opportunity of charge movement between adjacent molecules in a percolating fashion.

The thickness of the charge transport layer is not particularly limited, and is typically 5 μm or more, preferably 10 μm or more, and is typically 50 μm or less, preferably 45 μm or less, further preferably 30 μm or less in terms of longevity and image stability and charge stability. The thickness of the charge transport layer is particularly preferably 25 μm or less in terms of improving resolution.

### Monolayer Photosensitive Layer

The monolayer photosensitive layer is formed with the charge generating substance, the charge transport substance, and the binder resin. The binder resin is used to provide film strength, as with the case of the charge transport layer of the laminated photoreceptor. Specifically, the monolayer photosensitive layer may be obtained by dissolving or dispersing the charge generating substance, the charge transport substance, and any of various binder resins in a solvent, and applying and drying the resulting coating liquid on the electrocondutive support (on the underlayer when the underlayer is provided).

The types and the proportions of the charge transport substance and the binder resin are as described for the charge transport layer of the laminated photoreceptor. The charge generating substance is dispersed in a charge transport medium containing the charge transport substance and the binder resin.

The same charge generating substances described for the charge generating layer of the laminated photoreceptor may be used. In the case of a photoreceptor with the monolayer photosensitive layer, the charge generating substance needs to have a sufficiently small particle size. Specifically, the particle size is typically 1 μm or less, preferably 0.5 μm or less.

The proportions of the binder resin and the charge generating substance in the monolayer photosensitive layer are such that the charge generating substance is typically 0.1 mass parts or more, preferably 1 mass parts or more, and typically 30 mass parts or less, preferably 10 mass parts or less with respect to 100 mass parts of the binder resin.

The thickness of the monolayer photosensitive layer is typically 5 μm or more, preferably 10 μm or more, and typically 100 μm or less, preferably 50 μm or less.

### Other Functional Layers

In both the laminated photoreceptor and the monolayer photoreceptor, the photosensitive layer or the layers forming the photosensitive layer may contain additives such as an antioxidant, a plasticizer, a ultraviolet absorber, an electron withdrawing compound, a leveling agent, and a visible light blocking agent for the purpose of improving ease of deposition, flexibility, coatability, contamination resistance, gas resistance, and lightfastness. The antioxidant is preferably a hindered phenolic compound or a benzylamine derivative, particularly preferably a benzylamine derivative in terms of ozone resistance.

In both the laminated photoreceptor and the monolayer photoreceptor, the photosensitive layer formed by using the foregoing procedures may be the uppermost layer, specifically the surface layer. Alternatively, the surface layer may be some other layer formed on the photosensitive layer. For example, a protective layer may be provided for the purposes of preventing wear in the photosensitive layer, or preventing or relieving the deterioration of the photosensitive layer due to generated discharge products from a charger or the like. The protective layer may be adapted to contain the charge transport substance represented by the formula (1), and the polyester resin represented by the formula (2).

The electrical resistance of the protective layer is typically from 10⁹Ω·cm to 10¹⁴Ω·cm. An electrical resistance above this range may increase the residual electric potential and produce a heavily fogged image. On the other hand, an electrical resistance below this range may result in a blurred image or low resolutions. The protective layer needs to be configured so as not to essentially interfere with the passage of the irradiation light used for image exposure.

The surface layer may contain materials such as fluororesin, silicon resin, and polyethylene resin, particles made of such resin, or particles of inorganic compound for purposes including improving the frictional resistance of the photoreceptor surface, reducing wear, and increasing the transfer efficiency of toner from the photoreceptor to a transfer belt and paper. Alternatively, a layer containing such resins and particles may be newly formed as a surface layer.

### Elastic Deformation Rate of Outermost Surface Layer

In terms of abrasion resistance, the elastic deformation rate of the outermost surface layer containing the polyester resin having the structure unit represented by formula (2) is preferably 40% or more, and is preferably 44% or more, particularly preferably 46% or more for preventing toner adhesion.

In order to maintain high elastic deformation rate, the polyester resin having the structure unit represented by formula (2) is preferably polyallylate, a wholly aromatic polyester. Elastic deformation rate is measured in a 25° C., 50% relative humidity environment, using the microhardness meter FISCHERSCOPE H100C (Fischer product), or the equivalent HM2000 also available from Fischer. A Vickers right-pyramid diamond indenter with a face angle of 136° is used for measurement.

### Layer Forming Methods

The layers forming the photoreceptor are formed by using a coating liquid obtained by dissolving or dispersing the substance of interest in a solvent, and repeating the procedure of applying and drying the coating liquid on the electrocondutive support for each layer by using known methods such as dip coating, spray coating, nozzle coating, bar coating, roll coating, and blade coating.

The solvent or the dispersion medium used for the production of the coating liquid is not particularly limited. Specific examples include alcohols such as methanol, ethanol, propanol, and 2-methoxyethanol; ethers such as tetrahydrofuran, 1,4-dioxane, and dimethoxyethane; esters such as methyl formate, and ethyl acetate; ketones such as acetone, methyl ethyl ketone, cyclohexanone, and 4-methoxy-4-methyl-2-pentanone; aromatic hydrocarbons such as benzene, toluene, and xylene; chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene; nitrogen-containing compounds such as n-butylamine, isopropanolamine, diethylamine, triethanolamine, ethylenediamine, and triethylenediamine; and nonprotonic polar solvents such as acetonitrile, N-methylpyrrolidone, N,N-dimethylformamide, and dimethylsulfoxide. These may be used either alone or in any combination of two or more.

Amounts of the solvent or dispersion medium are not particularly limited, and are preferably appropriately adjusted to amounts with which the solid content, the viscosity, and other physical properties of the coating liquid fall in the desirable ranges, taking into account the intended use of each layer, and the properties of the selected solvent or dispersion medium.

For example, in the case of the charge transport layer of the monolayer photoreceptor or the function-separated photoreceptor, the solid content of the coating liquid is typically 5 mass % or more, preferably 10 mass % or more, and typically 40 mass % or less, preferably 35 mass % or less.

The viscosity of the coating liquid at operating temperature is typically 10 mPa·s or more, preferably 50 mPa·s or more, and typically 500 mPa·s or less, preferably 400 mPa·s or less.

In the case of the charge generating layer of the laminated photoreceptor, the solid content of the coating liquid is typically 0.1 mass % or more, preferably 1 mass % or more, and typically 15 mass % or less, preferably 10 mass % or less.

The viscosity of the coating liquid at operating temperature is typically 0.01 mPa·s or more, preferably 0.1 mPa·s or more, and typically 20 mPa·s or less, preferably 10 mPa·s or less.

The coating liquid may be applied by using methods such as dip coating, spray coating, spinner coating, bead coating, wire bar coating, blade coating, roll coating, air knife coating, and curtain coating. Other known coating methods also may be used.

Preferably, the coating liquid is dried by allowing the liquid to dry at room temperature until the surface is tack free, followed by heat drying at typically from 30° C. to 200° C. for 1 minute to 2 hours, either at rest or under a fan. The heating temperature may be constant, or the heating may be performed under varying drying temperatures.

### Image Forming Apparatus

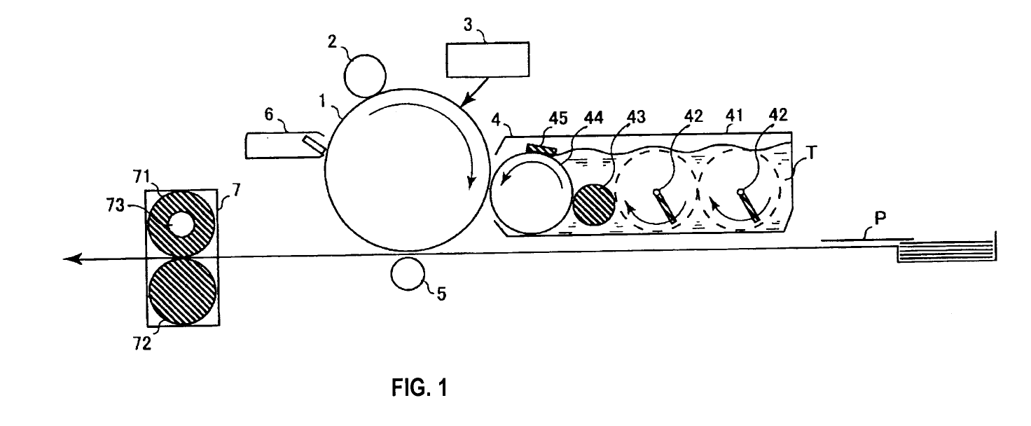

An embodiment of the image forming apparatus (image forming apparatus of the present invention) using the electrophotographic photoreceptor of the present invention is described below with reference to FIG. 1. FIG. 1 represents the configuration of the relevant portion of the apparatus. The following descriptions are not intended to limit the embodiment, and the embodiment may be practiced with modifications as may be appropriately made within the scope of the gist of the present invention.

As illustrated in FIG. 1, the image forming apparatus is configured to include an electrophotographic photoreceptor 1, a charging device 2, an exposure device 3, and a developing device 4, and also includes, as required, a transfer unit 5, a cleaning unit 6, and a fixing unit 7.

The electrophotographic photoreceptor 1 is not particularly limited, as long as it is the electrophotographic photoreceptor of the present invention. As an example, FIG. 1 shows a drum-like photoreceptor having a photosensitive layer on the surface of a cylindrical electrocondutive support. The charging device 2, the exposure device 3, the developing device 4, the transfer unit 5, and the cleaning unit 6 are disposed along the outer periphery of the electrophotographic photoreceptor 1.

The charging device 2 is provided to charge the electrophotographic photoreceptor 1, and uniformly brings the surface of the electrophotographic photoreceptor 1 to a predetermined electric potential. The charging device is typically, for example, a corona charging device such as a corotron and a scorotron; or a direct charging device (contact charging device) that charges the photoreceptor surface with a voltage-applied direct charge member in contact with the photoreceptor surface.

Examples of the direct charging device include a charge roller, and a charge brush. As an example, the charging device 2 shown in FIG. 1 is a roller-type charging device (charge roller). Direct charging may be performed by means of charging that involves aerial discharge, or injection charging that does not involve aerial discharge. The voltage applied for charging may be DC voltage, or DC voltage superimposed with AC voltage.

The exposure device 3 is not particularly limited, as long as it can form an electrostatic latent image of the photosurface of the electrophotographic photoreceptor 1 by exposing the electrophotographic photoreceptor 1. Specific examples include halogen lamps, fluorescent lamps, lasers such as semiconductor lasers and He—Ne lasers, and LED. Exposure may be performed by using a technique that exposes the photoreceptor from within the photoreceptor. Any light may be used for the exposure, including, for example, monochromatic light of 780 nm wavelength, monochromatic light of slightly shorter wavelengths within a 600 nm to 700 nm wavelength range, and short wavelength monochromatic light of 380 nm to 500 nm.

The developing device 4 is not particularly limited, and may be any device that uses a dry development technique (such as cascade development, one-component insulating toner development, one-component conductive toner development, and two-component magnetic brush development), or a wet development technique. The developing device 4 shown in FIG. 1 is configured from a development tank 41, agitators 42, a feed roller 43, a developing roller 44, and a regulation member 45, and stores toner T in the development tank 41. The developing device 4 may be provided with a replenisher (not illustrated) for replenishing toner T, as required. The replenisher is configured to enable replenishing toner T from a container such as a bottle, and a cartridge.

The feed roller 43 is formed of a material such as a conductive sponge. The developing roller 44 is formed as a metal roller of materials such as iron, stainless steel, aluminum, and nickel, or a resin roller of metal coated with resins such as silicon resin, urethane resin, and fluororesin. The surface of the developing roller 44 may be subjected to smoothing or roughening treatment, as required.

The developing roller 44 is disposed between the electrophotographic photoreceptor 1 and the feed roller 43, and is in contact with the electrophotographic photoreceptor 1 and the feed roller 43. The feed roller 43 and the developing roller 44 are rotated with a rotation driving mechanism (not illustrated). The feed roller 43 carries the stored toner T, and feeds it to the developing roller 44. The developing roller 44 carries the toner T supplied from the feed roller 43, and contacts the toner T to the surface of the electrophotographic photoreceptor 1.

The regulation member 45 is formed, for example, as a resin blade of materials such as silicon resin and urethane resin; a metal blade of materials such as stainless steel, aluminum, copper, brass, and phosphor bronze; or a resin-coated metal blade. The regulation member 45 is in contact with the developing roller 44, and is pressed against the developing roller 44 under a predetermined force of a spring or the like (typically, a blade linear pressure of 5 to 500 g/cm). The regulation member 45 may function to charge toner T by the frictionally charging toner T, as required.

The agitators 42 are rotated by the rotation driving mechanism, and agitate and transport toner T toward the feed roller 43. The agitators 42 may differ from each other by, for example, blade shape or size.

The toner T may be any toner, including a pulverized toner, and chemical toners obtained by using methods such as suspension polymerization, and emulsion polymerization. In the case of a chemical toner, it is preferable to use a chemical toner of a particle size as small as about 4 to 8 μm. The toner particle may have various shapes, from near spheres to non-spheres such as a potato shape. The chemical toners excel in charge uniformity and transferability, and are preferred for producing high image quality.

The transfer unit 5 is not particularly limited, and may be a device that uses any of various techniques, including electrostatic transfer (such as corona transfer, roller transfer, and belt transfer), pressure transfer, and adhesive transfer. In FIG. 1, the transfer unit 5 is disposed opposite the electrophotographic photoreceptor 1, and is configured from devices such as a transfer charger, a transfer roller, and a transfer belt.

The transfer unit 5 applies a predetermined voltage (transfer voltage) of the opposite polarity from the electric potential of the charged toner T, and transfers the toner image from the electrophotographic photoreceptor 1 to a recording paper (sheet, medium) P.

The cleaning unit 6 is not particularly limited, and may be any cleaning unit, including a brush cleaner, a magnetic brush cleaner, an electrostatic brush cleaner, a magnetic roller cleaner, and a blade cleaner.

The cleaning unit 6, with a cleaning member, scrapes off and collects the residual toner adhering to the photoreceptor 1. The cleaning unit 6 may be omitted when there is only a small amount of residual toner on the photoreceptor surface, or when there is hardly any residual toner.

The fixing unit 7 is configured from an upper fixing member (fixing roller) 71 and a lower fixing member (fixing roller) 72, and a heater 73 is provided in at least one of the fixing members 71 and 72. In the example shown in FIG. 1, the heater 73 is provided inside the upper fixing member 71.

The upper and lower fixing members 71 and 72 may be known heat fixing members such as a fixing roller obtained by coating silicon rubber over an original pipe of metals such as stainless steel and aluminum, a fixing roller coated with Teflon® resin, and a fixing sheet. The fixing members 71 and 72 may be configured to supply a releasing agent, such as silicon oil, to improve releasability, or may be configured to forcibly apply pressure with a spring or the like.

The toner transferred onto the recording paper P is heated to a molten state as it passes between the upper fixing member 71 and the lower fixing member 72 heated to a predetermined temperature. The toner is then fixed onto the recording paper P as it cools after leaving the upper fixing member 71 and the lower fixing member 72.

The fixing unit is not particularly limited, and may be any fixing unit using various techniques such as heat roller fixing, flash fixing, oven fixing, and pressure fixing, including the technique used herein.

The electrophotographic apparatus configured as above performs image recording as follows.

Specifically, first, the charging device 2 charges the surface (photosurface) of the photoreceptor 1 to a predetermined electric potential (for example, −600 V). Here, the surface may be charged with DC voltage, or DC voltage superimposed with AC voltage.

The exposure device 3 then exposes the charged photosurface of the photoreceptor 1 according to the image to be recorded, and forms an electrostatic latent image on the photosurface. The developing device 4 then develops the electrostatic latent image formed on the photosurface of the photoreceptor 1.

The developing device 4, with the regulation member (developing blade) 45, thins the toner T supplied from the feed roller 43, and frictionally charges the toner T at the predetermined polarity (here, negative polarity, the same as the electric potential of the charged photoreceptor 1). The toner T contacts the surface of the photoreceptor 1 by being carried and transported by the developing roller 44.

A toner image corresponding the electrostatic latent image is formed on the photosurface of the photoreceptor 1 upon the charged toner T carried by the developing roller 44 contacting the surface of the photoreceptor 1. The transfer unit 5 transfers the toner image to recording paper P. The cleaning unit 6 removes any residual untransferred toner remaining on the photosurface of the photoreceptor 1.

The recording paper P with the transferred toner image is passed through the fixing units 7 to heat fix the toner image onto the recording paper P and obtain the finished image.

The image forming apparatus of the foregoing configuration may be configured to perform, for example, a neutralization step. The neutralization step is the step of exposing and neutralizing the electrophotographic photoreceptor, and devices such as a fluorescent lamp and an LED are used for this purpose. The light used in the neutralization step is typically light having an exposure energy that is 3 or more times more intense than the exposure light.

The image forming apparatus may have various modified configurations, including, for example, a configuration that permits steps such as a pre-exposure step, and an auxiliary charging step, a configuration that performs offset printing, and a full-color tandem configuration that uses a plurality of toners.

The electrophotographic photoreceptor 1 may preferably be formed as an integrated cartridge that combines one or more of the charging device 2, the exposure device 3, the developing device 4, the transfer unit 5, the cleaning unit 6, and the fixing unit 7 (hereinafter, also referred to as “electrophotographic photoreceptor cartridge”, as appropriate).

The electrophotographic photoreceptor cartridge may be configured to be detachable from the main body of an electrophotographic apparatus such as a copier, and a laser beam printer. In this way, for example, the electrophotographic photoreceptor cartridge can be removed from the main body of the image forming apparatus when deterioration has occurred in the electrophotographic photoreceptor 1 or in some other member, and a new electrophotographic photoreceptor cartridge can be installed in the main body of the image forming apparatus. This makes the maintenance and service of the image forming apparatus easier.

### EXAMPLES

The embodiment of the present invention is described below in more detail using Examples. It should be noted that the following Examples are non-limiting examples, intended to further illustrate the present invention, and may be practiced with modifications as may be appropriately made within the scope of the gist of the present invention. In the following Examples and Comparative Examples, “part” means “mass part”, unless otherwise specified.

### EXAMPLE 1

### Production of Coating Liquid for Underlayer

A surface-treated titanium oxide obtained by mixing rutile-type titanium oxide (Ishihara Sangyo product TTO55N; average primary particle diameter 40 nm) and methyldimethoxysilane (3 mass % with respect to the titanium oxide; Toshiba Silicone product TSL8117) in a Henschel mixer was dispersed in a mixed solvent of methanol/1-propanol (mass ratio of 7/3) using a ball mill to obtain a surface-treated titanium oxide dispersion slurry.

The dispersion slurry, a methanol/1-propanol/toluene mixed solvent, and pellets of a copolymer polyamide of 60%/15%/5%/15%/5% ε-caprolactam [formula (A) below]/bis(4-amino-3-methylcyclohexyl)methane [formula (B) below]/hexamethylenediamine [formula (C) below]/decamethylene dicarboxylic acid [formula (D) below]/octadecamethylene dicarboxylic acid [formula (E) below] in terms of a composition molar ratio were stirred and mixed under heat to melt the polyamide pellets. This was followed by a ultrasonic dispersion process to produce a coating liquid for underlayer (18.0% solid content) containing methanol/1-propanol/toluene in a 7/1/2 mass ratio, and surface-treated titanium oxide/copolymer polyimide in a 3/1 mass ratio.

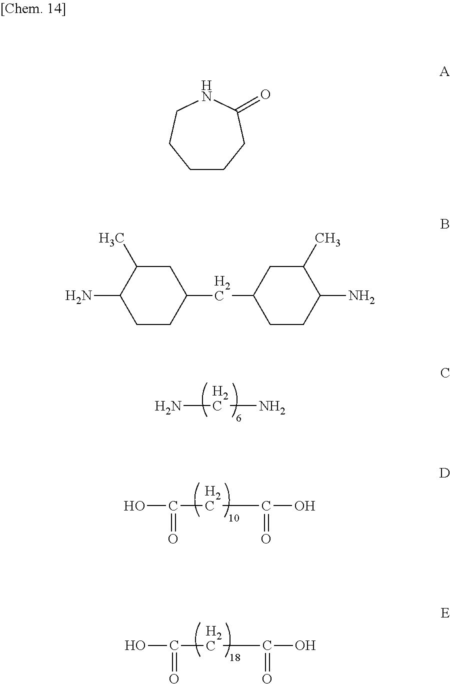

### Production of Coating Liquid for Charge Generating Layer

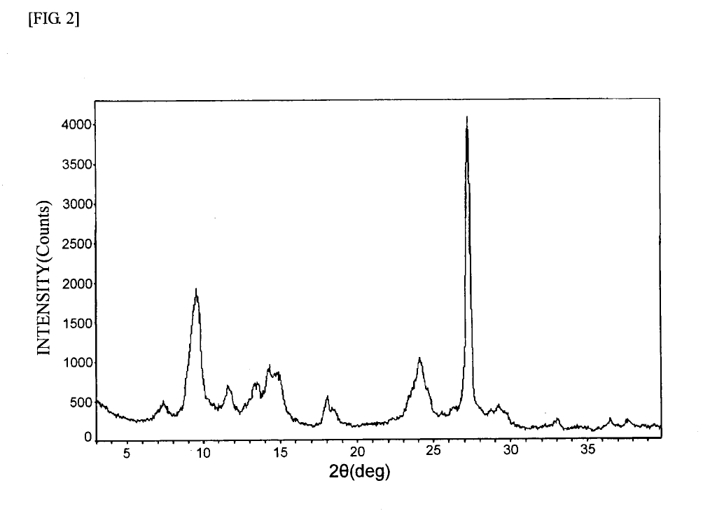

Y-form (also called D-form) oxytitanium phthalocyanine (20 parts; charge generating substance) that shows a strong diffraction peak at a Bragg angle (2θ±0.2°) of 27.3° in CuKα X-ray diffraction as shown in FIG. 2, and 1,2-dimethoxyethane (280 parts) were mixed, and pulverized with a sand grinding mill for 1 hour as a particulate dispersion process. A binder solution obtained by dissolving 10 parts of polyvinyl butyral (Denka product Denka Butyral #6000C) in a mixture of 1,2-dimethoxyethane (255 parts) and 4-methoxy-4-methyl-2-pentanone (85 parts), and 230 parts of 1,2-dimethoxyethane were mixed with the liquid obtained after the foregoing particulate dispersion process to prepare a coating liquid for charge generating layer.

### Production of Coating Liquid for Charge Transport Layer

A polyallylate resin having the repeating structure below (formula (X); viscosity average molecular weight 37,000; 100 parts), the compound represented by the formula CT1 (charge transport substance; 50 parts), an antioxidant (Ciba Specialty Chemicals product Irganox 1076; 8 parts), and a silicone oil (Shin-Etsu Silicone product KF96; 0.05 parts) were dissolved in 520 parts of a mixed solvent of tetrahydrofuran/toluene (8/2 mass ratio) to prepare a coating liquid for charge transport layer.

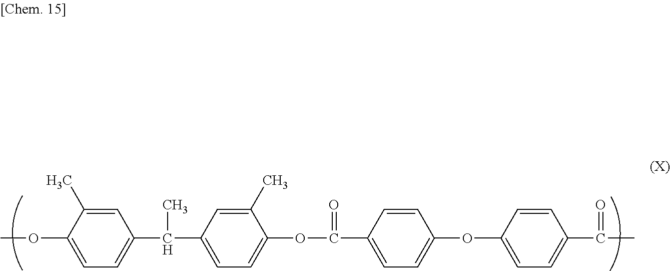

### Production of Photoreceptor

The coating liquid for underlayer obtained as above was applied onto a polyethylene terephthalate sheet that has had aluminum vapor-deposited on the sheet surface. The coating liquid was applied with a wire bar, and dried at a room temperature to obtain an underlayer having a dry thickness of about 1.3 μm.

Thereafter, the coating liquid for charge generating layer obtained as above was applied onto the underlayer with a wire bar, and dried at room temperature to obtain a charge generating layer having a dry thickness of about 0.3 μm.

The coating liquid for charge transport layer obtained as above was then applied with an applicator onto the charge generating layer, and dried at 125° C. for 20 minutes to produce a photoreceptor having a dry thickness of about 25 μm.

### Electrical Properties Test

A test was performed with an electrophotographic characteristics evaluation device produced according to the measurement standards of The Society of Electrophotography of Japan (Zoku Denshishashin Gijyutsu no Kiso to Ouyou, Ed., The Society of Electrophotography of Japan, Corona Publishing Co., Ltd., 1996, pp. 404 to 405). The sheet-shaped photoreceptor was wound around an aluminum cylinder (diameter 80 mm). After being ground, the photoreceptor was charged to an initial surface electric potential of about −700 V. By using 780-nm monochromatic light produced by filtering light from a halogen lamp through an interference filter, the exposure quantity (half exposure quantity; unit μj/cm²; E_{1/2}) at which the surface electric potential becomes ½ of the initial surface electric potential, and the surface electric potential (light electric potential; VL) under 0.6 μJ/cm² expose were determined.

The time from the exposure to the electric potential measurement was 100 ms. The measurements were performed in 25° C., 50% RH environment. Larger absolute values of VL mean poorer response. The test results are presented in Table-1.

### EXAMPLE 2

A photoreceptor was produced and evaluated in the same manner as in Example 1, except that the charge transport substance was changed from the compound represented by formula CT1 to the compound represented by formula CT5. The results are presented in Table-1.

### EXAMPLE 3

A photoreceptor was produced and evaluated in the same manner as in Example 1, except that the charge transport substance was changed from the compound represented by formula CT1 to the compound represented by formula CT22. The results are presented in Table-1.

### EXAMPLE 4

A photoreceptor was produced and evaluated in the same manner as in Example 1, except that the charge transport substance was changed from the compound represented by formula CT1 to the compound represented by formula CT7. The results are presented in Table-1.

### EXAMPLE 5

A photoreceptor was produced and evaluated in the same manner as in Example 1, except that the charge transport substance was changed from the compound represented by formula CT1 to the compound represented by formula CT20. The results are presented in Table-1.

### EXAMPLE 6

A photoreceptor was produced and evaluated in the same manner as in Example 1, except that the charge transport substance was changed from the compound represented by formula CT1 to the compound represented by formula CT2. The results are presented in Table-1.

### EXAMPLE 7

A photoreceptor was produced and evaluated in the same manner as in Example 1, except that the charge transport substance was changed from the compound represented by formula CT1 to the compound represented by formula CT10. The results are presented in Table-1.

### EXAMPLE 8

A photoreceptor was produced and evaluated in the same manner as in Example 1, except that the charge transport substance was changed from the compound represented by formula CT1 to the compound represented by formula CT8. The results are presented in Table-1.

### EXAMPLE 9

A photoreceptor was produced and evaluated in the same manner as in Example 2, except that the binder resin was changed from the resin represented by formula (X) to the binder resin represented by the formula (Y) below (viscosity average molecular weight 35,000; terephthalic acid:isophthalic acid=50:50). The results are presented in Table-1.

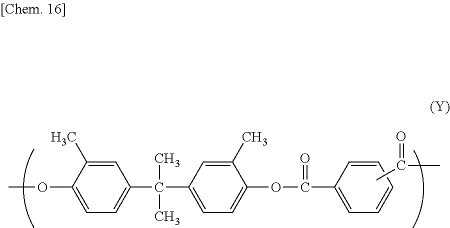

### EXAMPLE 10

A photoreceptor was produced and evaluated in the same manner as in Example 2, except that the binder resin was changed from the resin represented by formula (X) to the binder resin represented by the formula (Z) below (viscosity average molecular weight 47,000; m:n=70:30; terephthalic acid:isophthalic acid=50:50). The results are presented in Table-1.

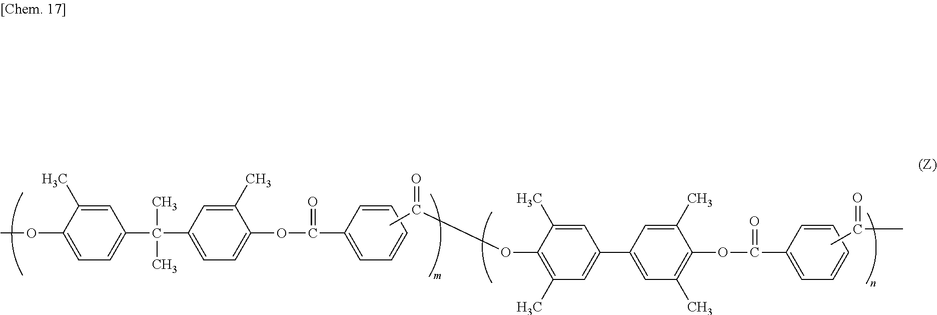

### COMPARATIVE EXAMPLE 1

A photoreceptor was produced and evaluated in the same manner as in Example 1, except that the charge transport substance was changed from the compound represented by formula CT1 to the compound represented by formula (CTA). The results are presented in Table-1.

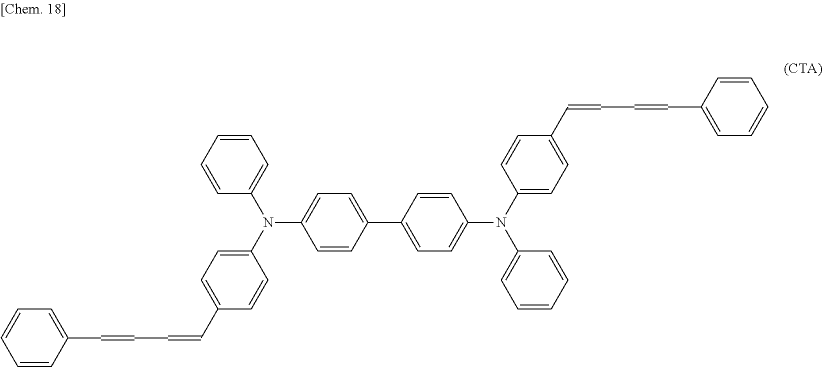 [SMILES: C(C=Cc1ccc(N(c2ccccc2)c2ccc(-c3ccc(N(c4ccccc4)c4ccc(C=CC=Cc5ccccc5)cc4)cc3)cc2)cc1)=Cc1ccccc1]

### COMPARATIVE EXAMPLE 2

A photoreceptor was produced and evaluated in the same manner as in Example 1, except that the charge transport substance was changed from the compound represented by formula CT1 to the compound represented by formula (CTB). The results are presented in Table-1.

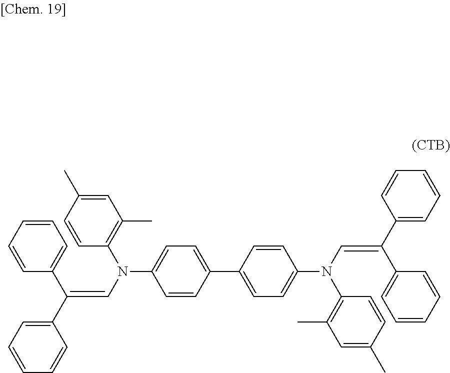 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

### COMPARATIVE EXAMPLE 3

A photoreceptor was produced and evaluated in the same manner as in Example 1, except that the charge transport substance was changed from the compound represented by formula CT1 to the compound represented by formula (CTC). The results are presented in Table-1.

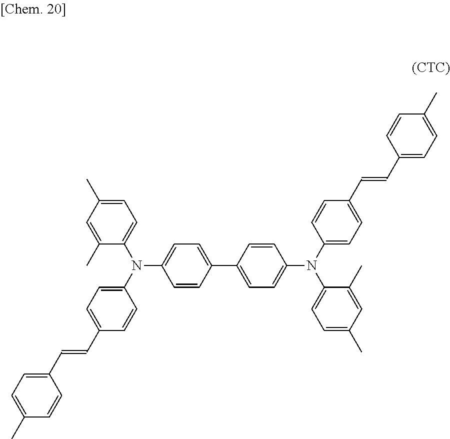 [SMILES: Cc1ccc(/C=C/c2ccc(N(c3ccc(-c4ccc(N(c5ccc(/C=C/c6ccc(C)cc6)cc5)c5ccc(C)cc5C)cc4)cc3)c3ccc(C)cc3C)cc2)cc1]

### COMPARATIVE EXAMPLE 4

A photoreceptor was produced and evaluated in the same manner as in Example 1, except that the charge transport substance was changed from the compound represented by formula CT1 to the compound represented by formula (CTD). The results are presented in Table-1.

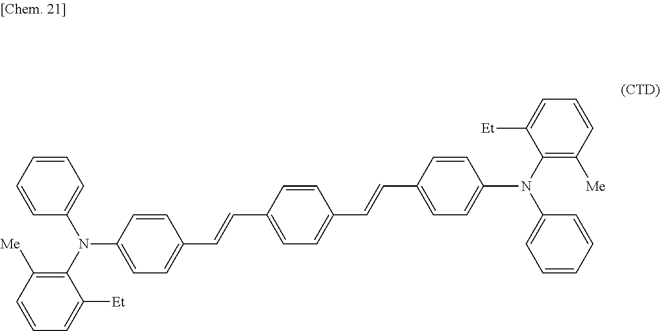 [SMILES: CCc1cccc(C)c1N(c1ccccc1)c1ccc(/C=C/c2ccc(/C=C/c3ccc(N(c4ccccc4)c4c(C)cccc4CC)cc3)cc2)cc1]

### COMPARATIVE EXAMPLE 5

A photoreceptor was produced and evaluated in the same manner as in Example 1, except that the charge transport substance was changed from the compound represented by formula CT1 to the compound represented by formula (CTE). The results are presented in Table-1.

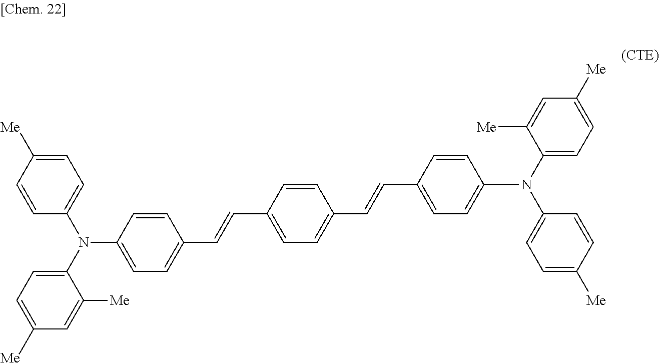 [SMILES: Cc1ccc(N(c2ccc(/C=C/c3ccc(/C=C/c4ccc(N(c5ccc(C)cc5)c5ccc(C)cc5C)cc4)cc3)cc2)c2ccc(C)cc2C)cc1]

### EXAMPLES 11 TO 13, AND COMPARATIVE EXAMPLES 6 TO 11

Photoreceptors were produced and evaluated in the same manner as in Example 1, except that the compound represented by formula CT1 used in 50 parts as the charge transport substance was changed to the charge transport substances of Table-1 and used in the proportions given in Table-1. The results are presented in Table-1.

### EXAMPLE 14

A photoreceptor was produced and evaluated in the same manner as in Example 2, except that the binder resin was changed from the resin represented by formula (X) to the binder resin represented by the formula (V) below (viscosity average molecular weight 30,000; terephthalic acid:isophthalic acid=50:50). The results are presented in Table-1.

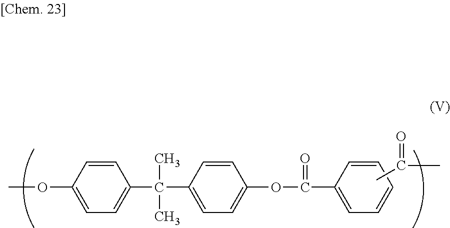

TABLE 1

| | Charge | | | | |
|---|---|---|---|---|---|
| | transport | | | E_{1/2} | |
| | substance | Part | Binder resin | (μJ/cm²) | VL (−V) |
| Ex. 1 | CT1 | 50 | X | 0.097 | 19 |
| Ex. 2 | CT5 | 50 | X | 0.098 | 13 |
| Ex. 3 | CT22 | 50 | X | 0.097 | 18 |
| Ex. 4 | CT7 | 50 | X | 0.093 | 17 |
| Ex. 5 | CT20 | 50 | X | 0.091 | 16 |
| Ex. 6 | CT2 | 50 | X | 0.093 | 18 |
| Ex. 7 | CT10 | 50 | X | 0.097 | 22 |
| Ex. 8 | CT8 | 50 | X | 0.096 | 18 |
| Ex. 9 | CT5 | 50 | Y | 0.101 | 19 |
| Ex. 10 | CT5 | 50 | Z | 0.103 | 21 |
| Ex. 14 | CT1 | 50 | V | 0.107 | 40 |
| Com. Ex. 1 | CTA | 50 | X | 0.100 | 115 |
| Com. Ex. 2 | CTB | 50 | X | 0.092 | 65 |
| Com. Ex. 3 | CTC | 50 | X | 0.086 | 32 |
| Com. Ex. 4 | CTD | 50 | X | 0.109 | 65 |
| Com. Ex. 5 | CTE | 50 | X | 0.104 | 50 |
| Ex. 11 | CT1 | 30 | X | 0.096 | 57 |
| Ex. 12 | CT1 | 35 | X | 0.093 | 41 |
| Ex. 13 | CT1 | 40 | X | 0.089 | 31 |
| Com. Ex. 6 | CTB | 30 | X | 0.094 | 136 |
| Com. Ex. 7 | CTB | 35 | X | 0.094 | 108 |
| Com. Ex. 8 | CTB | 40 | X | 0.094 | 92 |
| Com. Ex. 9 | CTC | 30 | X | 0.090 | 114 |
| Com. Ex. 10 | CTC | 35 | X | 0.090 | 79 |
| Com. Ex. 11 | CTC | 40 | X | 0.089 | 62 |

As can be seen from Table-1, the charge transport substances represented by formula (1) of the present invention show distinctly low exposure electric potentials even when used in small parts in the polyester resin.

### REFERENCE EXAMPLES 1 TO 13

Photoreceptors were produced and evaluated in the same manner as in Examples 1 to 8 and Comparative Examples 1 to 5, except that the binder resin represented by formula (X) was replaced with the polycarbonate resin (α:β=50:50; viscosity average molecular weight 40,000) of the structural formula (U) below. The results are presented in Table-2. In Table-2, ΔVL is the difference between the VL value (Table-1) for the polyallylate binder resin represented by formula (X) and the VL value (Table-2) for the polycarbonate binder resin represented by formula (U). Smaller ΔVL values mean that the extent of electrical property deterioration with polyallylate is smaller, and are desirable.

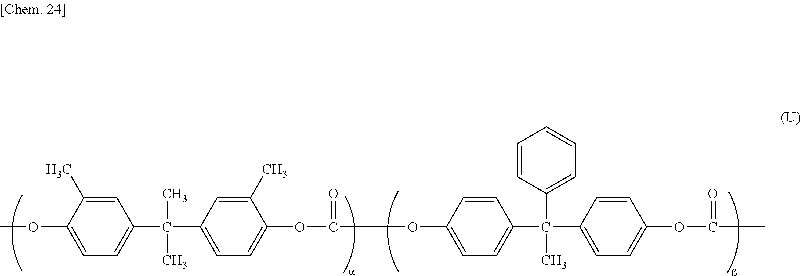

TABLE 2

| | Charge | | | | | |
|---|---|---|---|---|---|---|
| | transport | | Binder | E_{1/2} | | |
| | substance | Part | resin | (μJ/cm²) | VL (−V) | ΔVL (V) |
| Ref. | CT1 | 50 | U | 0.090 | 12 | 7 |
| Ex. 1 | | | | | | |
| Ref. | CT5 | 50 | U | 0.089 | 9 | 4 |
| Ex. 2 | | | | | | |
| Ref. | CT22 | 50 | U | 0.089 | 10 | 8 |
| Ex. 3 | | | | | | |
| Ref. | CT7 | 50 | U | 0.085 | 10 | 7 |
| Ex. 4 | | | | | | |
| Ref. | CT20 | 50 | U | 0.083 | 11 | 5 |
| Ex. 5 | | | | | | |
| Ref. | CT2 | 50 | U | 0.085 | 10 | 8 |
| Ex. 6 | | | | | | |
| Ref. | CT10 | 50 | U | 0.088 | 11 | 11 |
| Ex. 7 | | | | | | |
| Ref. | CT8 | 50 | U | 0.089 | 12 | 6 |
| Ex. 8 | | | | | | |
| Ref. | CTA | 50 | U | 0.087 | 53 | 62 |
| Ex. 9 | | | | | | |
| Ref. | CTB | 50 | U | 0.081 | 22 | 43 |
| Ex. 10 | | | | | | |
| Ref. | CTC | 50 | U | 0.076 | 9 | 23 |
| Ex. 11 | | | | | | |
| Ref. | CTD | 50 | U | 0.100 | 28 | 117 |
| Ex. 12 | | | | | | |
| Ref. | CTE | 50 | U | 0.097 | 19 | 31 |
| Ex. 13 | | | | | | |

As can be seen from Tables-1 and -2, the charge transport materials represented by formula (1) of the present invention do not involve large electrical property differences for the polycarbonate binder resin and the polyallylate binder resin, whereas the extent of electrical property deterioration with the polyallylate binder resin is greater in the charge transport materials used in Comparative Examples 1 to 5, and Reference Examples 9 to 13.

### EXAMPLE 15

### Production of Photoconductive Drum

The coating liquid for underlayer, the coating liquid for charge generating layer, and the coating liquid for charge transport layer used for the photoreceptor production in Example 12 were successively applied onto an aluminum cylinder that had been roughly machined on the surface and cleanly washed before use (outer diameter 30 mm, length 246 mm, thickness 0.75 mm), using a dip coating technique. These were dried to form an underlayer, a charge generating layer, and a charge transport layer having thicknesses of 1.3 μm, 0.4 μm and 25 μm, respectively, and a photoconductive drum was obtained. The charge transport layer was dried at 125° C. for 20 minutes.

### Image Test

The photoreceptor was installed in a photoreceptor cartridge of OKI tandem full-color printer C3100 (DC roller charging, LED exposure, contact non-magnetic one-component development), and continuously printed on 10,000 sheets at 5% printing ratio under 23° C., 50% relative humidity conditions. The images were desirable, and did not have image defects such as ghosting, fogging, low density, filming, insufficient cleaning, and scratch.

### COMPARATIVE EXAMPLE 12

A photoconductive drum was produced, and an image test was conducted in the same manner as in Example 15, except that the coating liquid for charge transport layer used for the photoreceptor production in Example 15 was replaced with the coating liquid for charge transport layer used in the photoreceptor production of Comparative Example 7. The result showed that the image density was low from the beginning, and deteriorated after continuous printing, and the images involved positive ghosting.

### COMPARATIVE EXAMPLE 13

A photoconductive drum was produced, and an image test was conducted in the same manner as in Example 15, except that the binder resin of formula (X) used in the coating liquid for charge transport layer in the photoreceptor production of Example 15 was replaced with the polycarbonate resin (viscosity average molecular weight 40,000) represented by the structural formula (W) below. Filming occurred after continuous printing, and the photosensitive layer had large wear, and scratches.

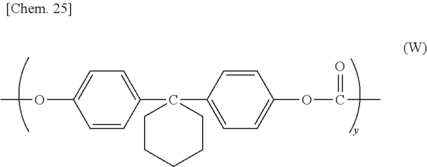

### EXAMPLE 16

### Production of Photoconductive Drum

The coating liquid for charge generating layer, and the coating liquid for charge transport layer used for the photoreceptor production in Example 13 were successively applied onto an aluminum cylinder that had been roughly machined on the surface, and that had been cleanly washed after being anodized (outer diameter 30 mm, length 246 mm, thickness 0.75 mm), using a dip coating technique. These were dried to form a charge generating layer and a charge transport layer having thicknesses of 0.3 μm and 18 μm, respectively, and a photoconductive drum was obtained. The charge transport layer was dried at 135° C. for 20 minutes.

### Adhesion Test

The photoreceptors were tested for the adhesion of the photosensitive layer by performing a grid adhesion test according to JIS K5600-5-6 (ISO 2409; 1999). The results were desirable, as shown in Table-3 (Excellent: very desirable; Good: desirable; Acceptable: not sufficient but acceptable; Poor: adhesion failure).

### Image Test

The photoreceptors were each installed in a photoreceptor cartridge of OKI tandem full-color printer C711dn (DC roller charging, LED exposure, contact non-magnetic one-component development), and intermittently printed on 12,500 sheets (with a pause after the printing of each sheet) at 5% printing ratio under 10° C., 15% relative humidity conditions. The result showed slight filming (toner component adhesion) on the drum, but the filming did not appear as image defects, and was tolerable, as shown in Table-3 (Excellent: very desirable; Good: desirable; Acceptable: not sufficient but acceptable; Poor: unacceptable). No other image defects were observed. The average wear on the photosensitive layer after the image testing of the photoreceptor was 1.4 μm thick.

### EXAMPLES 17 TO 20, AND COMPARATIVE EXAMPLES 14 TO 19

Photoconductive drums were produced and evaluated in the same manner as in Example 16, except that the charge transport substance and/or the binder resin were changed as shown in Table-3. The results are presented in Table-3. The binder resin used in Comparative Example 18 is the polycarbonate resin represented by the following structural formula (T) (viscosity average molecular weight 50,000; 6:E=60:40 (molar ratio)).

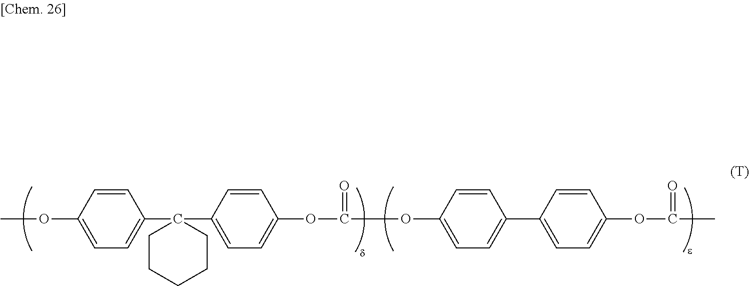

The binder resin used in Comparative Example 19 is the polyester resin represented by the following structural formula (S) (Mv=21,000; a:b:c:d=1:1:1:1 (molar ratio)).

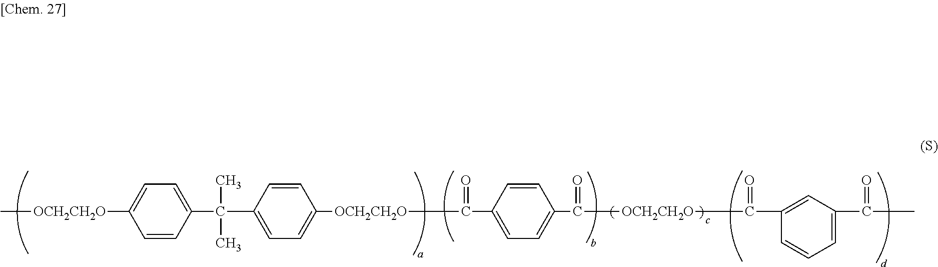

TABLE 3

| | | | | | | Wear in | |
|---|---|---|---|---|---|---|---|
| | Charge transport | | Binder | | Other image | photosensitive | |
| | substance | Part | resin | Filming | defects | layer (μm) | Adhesion |
| Ex. 16 | CT1 | 40 | X | Acceptable | Basically absent | 1.4 | Good |
| Ex. 17 | CT8 | 40 | X | Excellent | Basically absent | 1.4 | Good |
| Ex. 18 | CT8 | 40 | Y | Good | Basically absent | 1.8 | Good |
| Ex. 19 | CT8 | 40 | Z | Good | Basically absent | 1.6 | Good |
| Ex. 20 | CT8 | 40 | V | Acceptable | Slight cleaning | 2.2 | Good |
| | | | | | defect, slightly | | |
| | | | | | low image density | | |
| Com. | CTA | 40 | X | Acceptable | Low image density, | 1.8 | Acceptable |
| Ex. 14 | | | | | negative memory | | |
| Com. | CTB | 40 | X | Good | Low image density | 1.6 | Poor |
| Ex. 15 | | | | | | | |
| Com. | CTC | 40 | X | Acceptable | Low image density, | 1.6 | Acceptable |
| Ex. 16 | | | | | slight negative | | |
| | | | | | memory | | |
| Com. | CT8 | 40 | W | Poor | Fogging occurred | 2.7 | Good |
| Ex. 17 | | | | | toward the end of | | |
| | | | | | process, dot-like | | |
| | | | | | image defect due | | |
| | | | | | to filming | | |
| Com. | CT8 | 40 | T | Poor | Dot-like image | 2.0 | Poor |
| Ex. 18 | | | | | defect due to | | |
| | | | | | filming | | |
| Com. | CT8 | 40 | S | Poor | Fogging occurred | 6.5 | Poor |
| Ex. 19 | | | | | in the middle or | | |
| | | | | | process, dot-like | | |
| | | | | | image defect due | | |
| | | | | | to filming | | |

As can be seen from Table-3, the photoreceptors of the present invention had desirable abrasion resistance, a quality necessary for long life, and did not involve filming, film stripping, or other image defects, indicating that a high-quality, stable image can be formed throughout the life of the photoreceptor. The charge transport substance of formula (1) used in Examples was obtained by the coupling reaction of a triphenylamine derivative and an aniline compound.

While the present invention has been described in detail with reference to a specific embodiment, the present invention may be altered or modified in many ways within the spirit and scope of the present invention as would be apparent to a skilled person.

This application is based on Japanese patent application (No. 2012-170115) filed Jul. 31, 2012, the contents of which are hereby incorporated by reference.

### REFERENCE SIGNS LIST

1 Photoreceptor (electrophotographic photoreceptor)
2 Charging device (charging roller; charging member)
3 Exposure device (exposing member)
4 Developing device (developing member)
5 Transfer unit
6 Cleaning unit
7 Fixing unit
41 Development tank
42 Agitator
43 Feed roller
44 Developing roller
45 Regulation member
71 Upper fixing member (fixing roller)
72 Lower fixing member (fixing roller)
73 Heater
T Toner
P Recording paper (sheet, medium)

1. An electrophotographic photoreceptor comprising an electrocondutive support and at least a photosensitive layer on the support,
wherein the photosensitive layer contains a charge transport substance represented by the following formula (1), and a polyester resin having a structure unit represented by the following formula (2), 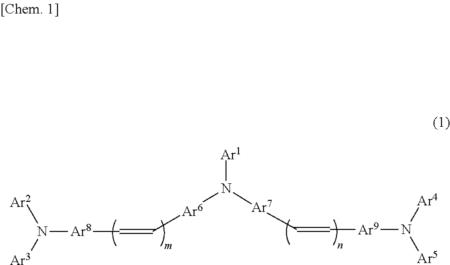
wherein Ar¹ to Ar⁵ each independently represent optionally substituted aryl group, Ar⁶ to Ar⁹ each independently represent optionally substituted arylene group, and m and n each independently represent an integer of 1 to 3, 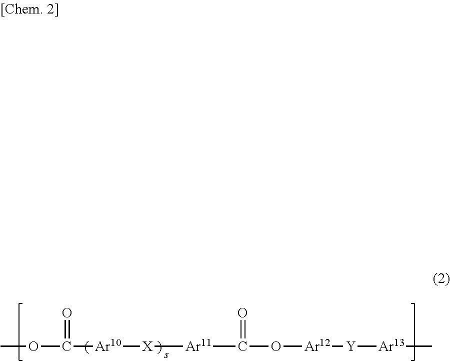
wherein Ar¹⁰ to Ar¹³ each independently represent optionally substituted arylene group, X and Y each independently represent a single bond, an oxygen atom, a sulfur atom, or alkylene group, and s represents an integer of 0 to 2, wherein, when s is 2, a plurality of Ar¹⁰s and Xs each may be the same or different.

2. The electrophotographic photoreceptor according to claim 1, wherein, in the formula (1), Ar¹ to Ar⁵ are each independently aryl group of 30 or less carbon atoms that may have alkyl group or alkoxy group, Ar⁶ to Ar⁹ are each independently optionally substituted 1,4-phenylene group, and m and n are each independently 1 or 2.

3. The electrophotographic photoreceptor according to claim 1, wherein the charge transport substance represented by the formula (1) contained in one or more layers forming the photosensitive layer is 15 to 50 mass parts with respect to 100 mass parts of a binder resin contained in the same layer.

4. The electrophotographic photoreceptor according to claim 1, wherein the photosensitive layer contains oxytitanium phthalocyanine of a crystal form that shows a diffraction peak at a Bragg angle (2θ±0.2°) of at least 24.1° and 27.2° in a powder X-ray diffraction spectrum using a CuKα characteristic X-ray.

5. The electrophotographic photoreceptor according to claim 1, wherein, when s in the formula (2) is 0, at least one of Ar¹² and Ar¹³ is an arylene group having an alkyl group.

6. The electrophotographic photoreceptor according to claim 1, wherein the photosensitive layer contains a benzylamine derivative.

7. A electrophotographic photoreceptor cartridge comprising:
the electrophotographic photoreceptor of claim 1; and
at least one device selected from the group consisting of:
a charging device that charges the electrophotographic photoreceptor;
an exposure device that exposes the charged electrophotographic photoreceptor and forms an electrostatic latent image; and
a developing device that develops the electrostatic latent image formed on the electrophotographic photoreceptor.

8. An image forming apparatus comprising:
the electrophotographic photoreceptor of claim 1;
a charging device that charges the electrophotographic photoreceptor;
an exposure device that exposes the charged electrophotographic photoreceptor and forms an electrostatic latent image; and
a developing device that develops the electrostatic latent image formed on the electrophotographic photoreceptor.
